(19) United States
(12) Patent Application Publication
(10) Pub. No.: US 2026/0105769 A1
(43) Pub. Date: Apr. 16, 2026

(54) SYSTEM AND METHOD FOR EXTRACTING CONTENT FROM RECORDS

(71) Applicant: Ancestry.com Operations Inc., Lehi, UT (US)

(72) Inventors: Siteng Chen, Lehi, UT (US); Kalyan Chakravarthi Murahari, Walnut Creek, CA (US); Pouyan Nahed, Las Vegas, NV (US); Masaki Stanley Fujimoto, Provo, UT (US)

(21) Appl. No.: 19/357,471

(22) Filed: Oct. 14, 2025

Related U.S. Application Data
(60) Provisional application No. 63/707,615, filed on Oct. 15, 2024.

(51) Int. Cl. G06V 30/414; G06F 40/284; G06V 10/774

(52) U.S. Cl. CPC G06V 30/414; G06F 40/284; G06V 10/774

(57) ABSTRACT

The present disclosure is directed toward systems, methods, and non-transitory computer-readable media for generating bounding boxes for an image in accordance with one or more embodiments. The disclosed systems can generate a set of hidden states for an image of a document. The disclosed systems can generate a set of bounding boxes and a set of tokens from the hidden states utilizing a first head component and a second head component of a record generation model. The disclosed systems can aggregate a plurality of bounding boxes into a bounding box group. Additionally, the disclosed systems can provide the image depicting the bounding box group for display within a graphical user interface of a client device. Additionally or alternatively, the disclosed systems can train the record generation model, in part, by determining that a loss associated with masking one or more training bounding boxes satisfies a threshold loss.

### CROSS-REFERENCE TO RELATED APPLICATIONS

This application claims the benefit of, and priority to, U.S. Provisional Application No. 63/707,615, entitled “SYSTEM AND METHOD FOR EXTRACTING CONTENT FROM RECORDS,” filed October 15, 2024, the contents of which are incorporated by reference herein in their entirety.

### FIELD

The disclosed embodiments relate to a machine learning model that extracts content from historical physical documents.

### BACKGROUND

Data-inheritance origins may be referred to as origins and describe how data may be inherited from real-world events. Data may be inherited and evolved based on real-world events that are not always recorded or documented. Yet, while the real-world events may not be completely documented, the change and inheritance of those events may be traceable by comparing data strings among data instances. For example, two data instances may be generated independently and individually reflect the status of their respective named entities or events. The data patterns in the data instances may reflect the natures, histories, or characteristics of data inheritance sources such as related or unrelated named entities or events. However, multiple data instances or corresponding named entities or events may be inherited from one or more common sources so that the data instances share some similarities in the data pattern. As such, the nature of inheritance may be revealed by analyzing and comparing the multiple data instances, and sometimes a large number of data instances. Those real-life events that result in shared data strings among data instances may be referred to as data inheritance events, even though those real-life events, at the time of the occurrence, may not involve data or data generation at all. For example, the real-life events may be historical events that occurred before the invention of computers or data but present data instances may still reflect those historical events.

### SUMMARY

Disclosed herein relates to example embodiments that extracts content from images of historical physical documents. For example, the disclosed systems can generate bounding boxes for display around records and/or fields of an image of a document. To illustrate, the disclosed systems can utilize a record generation model to generate a set of bounding boxes and a set of tokens from hidden states associated with an image. The disclosed systems can aggregate bounding boxes into a bounding box group corresponding to a subset of the tokens (e.g., the group of bounding boxes can indicate or depict a field or record in the document). The disclosed systems can provide the image depicting the bounding box group for display at a client device. For example, the disclosed systems can generate a rectangular box enclosing an area of the image that includes a field or record (or other data) extracted from the image of the document.

The method may include inputting an image into a machine learning model configured for content extraction, the machine learning model comprising, e.g., a transformer and a decoder, wherein the decoder is configured to cooperate with one or more token heads and/or bounding-box heads. The method may also include training a machine learning model for extracting structured data from images of historical physical documents. The method includes retraining the machine learning model by: initiating a bounding box for an image in a training sample, the bounding box defines an area of interest of the image; generating a plurality of tokens from the image, wherein a token represents a unit of data; masking a region in the image to hide one or more tokens; generating structure data prediction corresponding to the bounding box using the image with the masked region; generating a comparison between the structured data prediction corresponding to the bounding box and a ground truth of tokens that should be captured by the bounding box; and updating parameters of the bounding box based on the comparison.

In yet another embodiment, a non-transitory computer-readable medium that is configured to store instructions is described. The instructions, when executed by one or more processors, cause the one or more processors to perform a process that includes steps described in the above computer-implemented methods or described in any embodiments of this disclosure. In yet another embodiment, a system may include one or more processors and a storage medium that is configured to store instructions. The instructions, when executed by one or more processors, cause the one or more processors to perform a process that includes steps described in the above computer-implemented methods or described in any embodiments of this disclosure.

### BRIEF DESCRIPTION OF THE DRAWINGS

FIG. 1 illustrates a diagram of a system environment of an example computing system, in accordance with some embodiments.

FIG. 2 is a block diagram of an architecture of an example computing system, in accordance with some embodiments.

FIG. 3 is a flowchart depicting an example process for training a machine learning model that extracts structured data from images of historical physical documents, in accordance with some embodiments.

FIG. 4A illustrates an overview of the content extraction and training architecture, in accordance with some embodiments.

FIG. 4B illustrates a transformer model architecture according to the content extraction and training architecture of FIG. 4A according to an embodiment.

FIG. 4C illustrates a transformer block of a transformer model according to the content extraction and training architecture of FIG. 4A according to an embodiment.

FIG. 5 illustrates training a machine learning model using images with bounding box proposals and record ground truth data, in accordance with some embodiments.

FIG. 6 illustrates an example architecture for the record management system to generate bounding boxes and tokens in accordance with one or more embodiments.

FIG. 7 illustrates two examples of training architectures for training a record generation model in accordance with one or more embodiments.

FIG. 8 illustrates an example series of acts for providing an image depicting a bounding box group in accordance with one or more embodiments.

FIG. 9 illustrates an example diagram of a genealogical-data system interfacing with a genealogical database in accordance with one or more embodiments.

FIG. 10 is a block diagram of an example computing device, in accordance with some embodiments.

FIG. 11 illustrates an exemplary computing environment in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The figures(FIGS.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Example System Environment

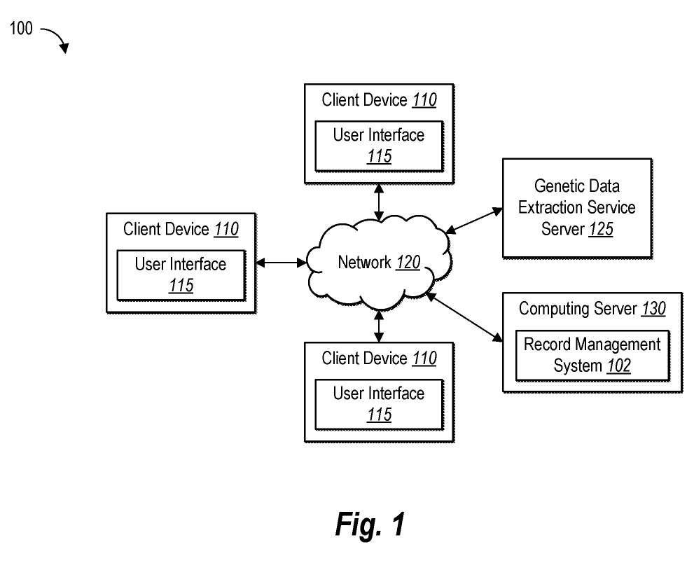

FIG. 1 illustrates a diagram of a system environment 100 of an example computing server 130, in accordance with some embodiments. The system environment 100 can include, host, or otherwise facilitate a record management system 102 (e.g., on the computing server 130). Additionally, the system environment 100 shown in FIG. 1 includes one or more client devices 110, a network 120, a genetic data extraction service server 125, and a computing server 130. In various embodiments, the system environment 100 may include fewer or additional components. The system environment 100 may also include different components.

The client devices 110 are one or more computing devices capable of receiving user input as well as transmitting and/or receiving data via a network 120. Example computing devices include desktop computers, laptop computers, personal digital assistants (PDAs), smartphones, tablets, wearable electronic devices (e.g., smartwatches), smart household appliances (e.g., smart televisions, smart speakers, smart home hubs), Internet of Things (IoT) devices or other suitable electronic devices. A client device 110 communicates to other components via the network 120. Users may be customers of the computing server 130 or any individuals who access the system of the computing server 130, such as an online website or a mobile application. In some embodiments, a client device 110 executes an application that launches a graphical user interface (GUI) for a user of the client device 110 to interact with the computing server 130. The GUI may be an example of a user interface 115. A client device 110 may also execute a web browser application to enable interactions between the client device 110 and the computing server 130 via the network 120. In another embodiment, the user interface 115 may take the form of a software application published by the computing server 130 and installed on the user device 110. In yet another embodiment, a client device 110 interacts with the computing server 130 through an application programming interface (API) running on a native operating system of the client device 110, such as IOS or ANDROID.

The network 120 provides connections to the components of the system environment 100 through one or more sub-networks, which may include any combination of local area and/or wide area networks, using both wired and/or wireless communication systems. In some embodiments, a network 120 uses standard communications technologies and/or protocols. For example, a network 120 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 120 may be represented using any suitable format, such as hypertext markup language (HTML) or extensible markup language (XML). In some embodiments, all or some of the communication links of a network 120 may be encrypted using any suitable technique or techniques such as secure sockets layer (SSL), transport layer security (TLS), virtual private networks (VPNs), Internet Protocol security (IPsec), etc. The network 120 also includes links and packet-switching networks such as the Internet.

Individuals, who may be customers of a company operating the computing server 130, provide biological samples for analysis of their genetic data. Individuals may also be referred to as users. In some embodiments, an individual uses a sample collection kit to provide a biological sample (e.g., saliva, blood, hair, tissue) from which genetic data is extracted and determined according to nucleotide processing techniques such as microarray, amplification and/or sequencing. Microarray may include immobilizing probe DNA sequences, onto a solid surface such as a glass slide. Target DNA samples, labeled with fluorescent tags, are then applied to the microarray surface. Through complementary base pairing, the labeled DNA binds to its corresponding probe on the microarray. By detecting the fluorescence emitted by the labeled DNA, genetic data may be extracted. Amplification may include using polymerase chain reaction (PCR) to amplify segments of nucleotide samples. Sequencing may include sequencing of deoxyribonucleic acid (DNA) sequencing, ribonucleic acid (RNA) sequencing, etc. Suitable sequencing techniques may include Sanger sequencing and massively parallel sequencing such as various next-generation sequencing (NGS) techniques including whole genome sequencing, pyrosequencing, sequencing by synthesis, sequencing by ligation, and ion semiconductor sequencing. In some embodiments, a set of SNPs (e.g., 300000) that are shared between different array platforms (e.g., Illumina OmniExpress Platform and Illumina HumanHap 650Y Platform) may be obtained as genetic data. Genetic data extraction service server 125 receives biological samples from users of the computing server 130. The genetic data extraction service server 125 extracts genetic data from the samples and the data may take the form of a set of SNPs. The genetic data extraction service server 125 generates the genetic data of the individuals based on sequencing or microarray results. The genetic data may include data generated from DNA or RNA and may include base pairs from coding and/or noncoding regions of DNA.

The genetic data may take different forms and include information regarding various biomarkers of an individual. For example, in some embodiments, the genetic data may be the base pair sequence of an individual. The base pair sequence may include the whole genome or a part of the genome such as certain genetic loci of interest. In another embodiment, the genetic data extraction service server 125 may determine genotypes from DNA identification results, for example by identifying genotype values of single nucleotide polymorphisms (SNPs) present within the DNA. The results in this example may include a sequence of genotypes corresponding to various SNP sites. A SNP site may also be referred to as a SNP locus. A genetic locus is a segment of a genetic sequence. A locus can be a single site or a longer stretch. The segment can be a single base long or multiple bases long. In some embodiments, the genetic data extraction service server 125 may perform data pre-processing of the genetic data to convert raw sequences of base pairs to sequences of genotypes at or genotyping data of target SNP sites. Since a typical human genome may differ from a reference human genome at only several million SNP sites (as opposed to billions of base pairs in the whole genome), the genetic data extraction service server 125 may extract only the genotypes at or genotyping data of a set of target SNP sites and transmit the extracted data to the computing server 130 as the inheritance dataset of an individual. SNPs, base pair sequences, genotypes, haplotypes, RNA sequences, protein sequences, and phenotypes are examples of biomarkers. In some embodiments, each SNP site may have two readings that are heterozygous.

The computing server 130 performs various analyses of the genetic data, genealogy data, and users’ survey responses to generate results regarding the phenotypes and genealogy of users of computing server 130. Depending on the embodiments, the computing server 130 may also be referred to as an online server, a personal genetic service server, a genealogy server, a family tree building server, and/or a social networking system. The computing server 130 receives genetic data from the genetic data extraction service server 125 and stores the genetic data in the data store of the computing server 130. The computing server 130 may analyze the data to generate results regarding the genetics or genealogy of users. The results regarding the genetics or genealogy of users may include the ethnicity compositions of users, paternal and maternal genetic analysis, identification or suggestion of potential family relatives, ancestor information, analyses of DNA data, potential or identified traits such as phenotypes of users (e.g., diseases, appearance traits, other genetic characteristics, and other non-genetic characteristics including social characteristics), etc. The computing server 130 may present or cause the user interface 115 to present the results to the users through a GUI displayed on the client device 110. The results may include graphical elements, textual information, data, charts, and other elements such as family trees.

In some embodiments, the computing server 130 also allows various users to create one or more genealogical profiles of the user. The genealogical profile may include a list of individuals (e.g., ancestors, relatives, friends, and other people of interest) who are added or selected by the user or suggested by the computing server 130 based on the genealogical records and/or genetic records. The user interface 115 controlled by or in communication with the computing server 130 may display the individuals in a list or as a family tree such as in the form of a pedigree chart. In some embodiments, subject to the user’s privacy setting and authorization, the computing server 130 may allow information generated from the user’s inheritance dataset to be linked to the user profile and to one or more of the family trees. The users may also authorize the computing server 130 to analyze their inheritance dataset and allow their profiles to be discovered by other users.

Some conventional systems for data management can exhibit a number of technical challenges related to clarity, accuracy, flexibility, and efficiency. Regarding clarity, prior systems may be unable to extract positional data for information in an image (e.g., an image of a historical document). Further, prior systems may be unable to depict or otherwise indicate where information in the image is located. As a result, user interfaces of prior systems can be deficient. For example, a document can have many different fields of information. A client device can be unable to determine where a record or field of interest to the client device is located in the document. Thus, a user of a client device may have a relatively poor user experience trying to determine whether particular information exists in an image of a document and/or where such information may be located amongst a relatively large amount of information.

Additionally, prior systems can be relatively inaccurate. For example, even if prior systems can generate boxes to project onto an image, such boxes may be too large (e.g., the box may include more information than desired) and/or too small (e.g., the box may fail to include relevant information). For example, information in a document that corresponds to an entity can be spread across multiple areas, or an area can include multiple types of information. Conventional systems may be unable to accurately group related information or generate boxes that accurately include relevant information while excluding information that is not associated with an entity.

Moreover, prior systems can be operationally inflexible. For example, existing systems can be unable to process or structure data from a variety of different sources and types of documents. For instance, documents can have different purposes, include different types of information, or have different structures for the information in the document. Some prior systems may be unable to flexibly interpret or process such a variety of documents (e.g., prior systems may generate inaccurate information or otherwise fail to perform processing operations when a document having a varying structure is provided as an input).

Further, prior systems can be computationally inefficient. For example, prior systems can consume a relatively large amount of processing power and experience relatively high latency in performing data extraction and structuring. Further, prior systems can experience such computational inefficiencies when training models associated with data extraction. To illustrate, prior systems may expend unnecessary computer resources to determine structural or other information of an input due to generating inaccurate initial outputs in training, inference, or both (e.g., the system may be required to perform more iterations in training to obtain accurate results due to such relatively poor initial outputs).

To overcome these deficiencies in prior systems, the record management system 102 can perform a number of acts or processes. The record management system 102 can determine data of an image and positional information associated with the data. For example, the record management system 102 can generate bounding boxes enclosing or indicating information of records, fields, or both in an image of a document. To illustrate, in one or more embodiments the record management system 102 can include a record generation model configured to generate a set of tokens representing information in the image and a set of bounding boxes indicating a position of respective tokens in the image. Further, the record management system 102 can aggregate bounding boxes into a bounding box group (e.g., utilizing a matcher component of the record generation model). The record management system 102 can generate a depiction of the bounding box group and provide an image with the depiction of the group. For example, the record management system 102 can aggregate bounding boxes associated with tokens of a record into a single bounding box and display the image with the single bounding box enclosing or highlighting the associated record via a graphical user interface of a client device.

Additionally or alternatively, the record management system 102 can train one or more models as described herein. For example, the record management system 102 can mask a bounding box and use one or more machine learning models to predict data in the image including the masked bounding box. The record management system 102 can calculate a loss associated with the predicted data and determine that the masked box corresponds to a token based on the loss satisfying a threshold loss. The record management system 102 can adjust one or more parameters of one or more models based on the loss between the masked box and the associated token. Additionally or alternatively, the record management system 102 can generate “ground truth” training datasets. For example, in addition or alternative to utilizing bounding boxes that have been manually annotated with labeled fields or records, the record management system 102 can determine ground truth locations for bounding boxes to include in a training dataset by masking a box and determining that a subset of tokens are included in the area of the masked box based on a loss metric as described herein.

As suggested herein, the record management system 102 can provide several improvements over conventional systems. For example, the record management system 102 can improve clarity for a client device and improve a user experience by providing an improved user interface for the client device. To illustrate, the record management system 102 can generate a bounding box that covers multiple tokens associated with a field or record. Thus, the graphical user interface can clearly indicate information of a field or record (e.g., a record of information associated with a particular individual can be highlighted or otherwise indicated by one or more bounding boxes to render such information more distinguishable from other fields and records in the image of the document). Such an improved interface can help users identify particular information in an image, validate that information extracted from the image aligns with the portion of the image including the information, or both.

Moreover, the record management system 102 can realize improved accuracy over prior systems. For instance, prior systems can be unable to extract or determine positional information and content information from an image. Thus, even if a system can generate bounding boxes for an image, the bounding boxes can be inaccurate and fail to include relevant information or include unnecessary additional information. To illustrate, information in a document can be spread across multiple cells (e.g., information related to an individual in a record can include information across multiple fields or cells of a document or information of a field can be written across usual cell lines) and the resulting bounding boxes can fail to accurately reflect relevant information. By using both content information to determine the relation of data in the image (e.g., determining that a set of tokens corresponds to a single record or field) and creating bounding boxes utilizing that content information (e.g., matching bounding boxes to tokens as described herein), the record management system 102 can realize improved accuracy of bounding boxes to more accurately reflect relevant information in an image.

Further, in one or more embodiments the record management system 102 can improve operational flexibility compared to prior systems. Indeed, conventional systems can have poor performance or relatively high costs associated with processing multiple formats or types of data sources (e.g., different types of documents). By implementing the techniques described herein, the record management system 102 enables machine learning models to be able to process multiple types of documents with a relatively high performance. For instance, the record management system 102 can determine structural information and content information of an image of a document and accurately generate bounding boxes for different fields, records, or other types of information across images depicting multiple different types of data entry structures or containing different types of information.

Additionally, the record management system 102 improves computational efficiency compared to conventional systems. For example, by utilizing the content and positional information for bounding box generation and/or aggregation as described herein, the record management system 102 improves the performance of the various machine learning models. For example, the machine learning models can operate with less latency (e.g., relatively less time) and less power consumption compared to conventional models. To illustrate, by matching predicted bounding boxes to tokens, the record management system 102 can select initial bounding boxes with a relatively high accuracy, reducing overall computation time and power, among other benefits.

### Example Computing Server Architecture

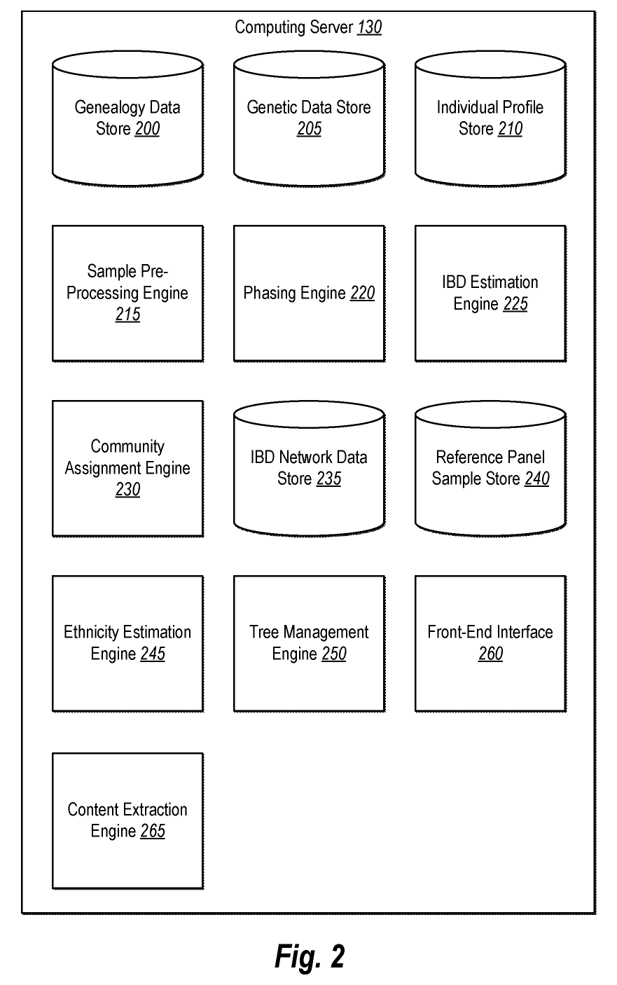

FIG. 2 is a block diagram of the architecture of an example computing server 130 (e.g., housing the record management system 102 and/or additional components accessible by the record management system 102) in accordance with some embodiments. In the embodiment shown in FIG. 2, the computing server 130 includes a genealogy data store 200, a genetic data store 205, an individual profile store 210, a sample pre-processing engine 215, a phasing engine 220, an identity by descent (IBD) estimation engine 225, a community assignment engine 230, an IBD network data store 235, a reference panel sample store 240, an ethnicity estimation engine 245, a tree management engine 250, a front-end interface 260, and a content extraction engine 265. The functions of the computing server 130 may be distributed among the elements in a different manner than described. In various embodiments, the computing server 130 may include different components and fewer or additional components. Each of the various data stores may be a single storage device, a server controlling multiple storage devices, or a distributed network that is accessible through multiple nodes (e.g., a cloud storage system).

The computing server 130 stores various data of different individuals, including genetic data, genealogy data, and survey response data. The computing server 130 processes the genetic data of users to identify shared identity-by-descent (IBD) segments between individuals. The genealogy data and survey response data may be part of user profile data. The amount and type of user profile data stored for each user may vary based on the information of a user, which is provided by the user as she creates an account and profile at a system operated by the computing server 130 and continues to build her profile, family tree, and social network at the system and to link her profile with her genetic data. Users may provide data via the user interface 115 of a client device 110. Initially and as a user continues to build her genealogical profile, the user may be prompted to answer questions related to the basic information of the user (e.g., name, date of birth, birthplace, etc.) and later on more advanced questions that may be useful for obtaining additional genealogy data. The computing server 130 may also include survey questions regarding various traits of the users such as the users’ phenotypes, characteristics, preferences, habits, lifestyle, environment, etc.

Genealogy data may be stored in the genealogy data store 200 and may include various types of data that are related to tracing family relatives of users. Examples of genealogy data include names (first, last, middle, suffixes), gender, birth locations, date of birth, date of death, marriage information, spouse’s information kinships, family history, dates and places for life events (e.g., birth and death), other vital data, and the like. In some instances, family history can take the form of a pedigree of an individual (e.g., the recorded relationships in the family). The family tree information associated with an individual may include one or more specified nodes. Each node in the family tree represents the individual, an ancestor of the individual who might have passed down genetic material to the individual, and the individual’s other relatives including siblings, cousins, and offspring in some cases. Genealogy data may also include connections and relationships among users of the computing server 130. The information related to the connections between a user and her relatives that may be associated with a family tree may also be referred to as pedigree data or family tree data.

In addition to user-input data, genealogy data may also take other forms that are obtained from various sources such as public records and third-party data collectors. For example, genealogical records from public sources include birth records, marriage records, death records, census records, court records, probate records, adoption records, obituary records, etc. Likewise, genealogy data may include data from one or more family trees of an individual, the Ancestry World Tree system, a Social Security Death Index database, the World Family Tree system, a birth certificate database, a death certificate database, a marriage certificate database, an adoption database, a draft registration database, a veterans database, a military database, a property records database, a census database, a voter registration database, a phone database, an address database, a newspaper database, an immigration database, a family history records database, a local history records database, a business registration database, a motor vehicle database, and the like.

Furthermore, the genealogy data store 200 may also include relationship information inferred from the genetic data stored in the genetic data store 205 and information received from the individuals. For example, the relationship information may indicate which individuals are genetically related, how they are related, how many generations back they share common ancestors, lengths and locations of IBD segments shared, which genetic communities an individual is a part of, variants carried by the individual, and the like.

The computing server 130 maintains inheritance datasets of individuals in the genetic data store 205. An inheritance dataset of an individual may be a digital dataset of nucleotide data (e.g., SNP data) and corresponding metadata. For example, an inheritance dataset may be genetic data extracted by the genetic data extraction service server 125. An inheritance dataset may contain data on the whole or portions of an individual’s genome. The genetic data store 205 may store a pointer to a location associated with the genealogy data store 200 associated with the individual. An inheritance dataset may take different forms. In some embodiments, an inheritance dataset may take the form of a base pair sequence of the sequencing result of an individual. A base pair sequence dataset may include the whole genome of the individual (e.g., obtained from a whole-genome sequencing) or some parts of the genome (e.g., genetic loci of interest). A microarray data may take the form of SNP data at target positions in the genome.

In another embodiment, an inheritance dataset may take the form of sequences of genetic markers. Examples of genetic markers may include target SNP sites (e.g., allele sites) filtered from the DNA identification results. A SNP site that is a single base pair long may also be referred to as a SNP locus. A SNP site may be associated with a unique identifier. The inheritance dataset may be in the form of diploid data that includes a sequence of genotypes, such as genotypes at or genotyping data of the target SNP site, or the whole base pair sequence that includes genotypes at or genotyping data of known SNP sites and other base pair sites that are not commonly associated with known SNPs. The diploid dataset may be referred to as a genotype dataset or a genotype sequence. Genotype may have a different meaning in various contexts. In one context, an individual’s genotype may refer to a collection of diploid alleles of an individual. In other contexts, a genotype may be a pair of alleles present on two chromosomes for an individual at a given genetic marker such as a SNP site.

Genotype data for a SNP site may include a pair of alleles. The pair of alleles may be homozygous (e.g., A-A or G-G) or heterozygous (e.g., A-T, C-T). Instead of storing the actual nucleotides, the genetic data store 205 may store genetic data that are converted to bits. For a given SNP site, oftentimes only two nucleotide alleles (instead of all 4) are observed. As such, a 2-bit number may represent a SNP site. For example, 00 may represent homozygous first alleles, 11 may represent homozygous second alleles, and 01 or 10 may represent heterozygous alleles. A separate library may store what nucleotide corresponds to the first allele and what nucleotide corresponds to the second allele at a given SNP site.

A diploid dataset may also be phased into two sets of haploid data, one corresponding to a first parent side and another corresponding to a second parent side. The phased datasets may be referred to as haplotype datasets or haplotype sequences. Similar to genotype, haplotype may have a different meaning in various contexts. In one context, a haplotype may also refer to a collection of alleles that corresponds to a genetic segment. In other contexts, a haplotype may refer to a specific allele at a SNP site. For example, a sequence of haplotypes may refer to a sequence of alleles of an individual that are inherited from a parent.

The individual profile store 210 stores profiles and related metadata associated with various individuals appeared in the computing server 130. A computing server 130 may use unique individual identifiers to identify various users and other non-users that might appear in other data sources such as ancestors or historical persons who appear in any family tree or genealogy database. A unique individual identifier may be a hash of certain identification information of an individual, such as a user’s account name, user’s name, date of birth, location of birth, or any suitable combination of the information. The profile data related to an individual may be stored as metadata associated with an individual’s profile. For example, the unique individual identifier and the metadata may be stored as a key-value pair using the unique individual identifier as a key.

An individual’s profile data may include various kinds of information related to the individual. The metadata about the individual may include one or more pointers associating inheritance datasets such as genotype and phased haplotype data of the individual that are saved in the genetic data store 205. The metadata about the individual may also be individual information related to family trees and pedigree datasets that include the individual. The profile data may further include declarative information about the user that was authorized by the user to be shared and may also include information inferred by the computing server 130. Other examples of information stored in a user profile may include biographic, demographic, and other types of descriptive information such as work experience, educational history, gender, hobbies, preferences, location and the like. In some embodiments, the user profile data may also include one or more photos of the users and photos of relatives (e.g., ancestors) of the users that are uploaded by the users. A user may authorize the computing server 130 to analyze one or more photos to extract information, such as the user’s or relative’s appearance traits (e.g., blue eyes, curved hair, etc.), from the photos. The appearance traits and other information extracted from the photos may also be saved in the profile store. In some cases, the computing server may allow users to upload many different photos of the users, their relatives, and even friends. User profile data may also be obtained from other suitable sources, including historical records (e.g., records related to an ancestor), medical records, military records, photographs, other records indicating one or more traits, and other suitable recorded data.

For example, the computing server 130 may present various survey questions to its users from time to time. The responses to the survey questions may be stored at individual profile store 210. The survey questions may be related to various aspects of the users and the users’ families. Some survey questions may be related to users’ phenotypes, while other questions may be related to the environmental factors of the users.

Survey questions may concern health or disease-related phenotypes, such as questions related to the presence or absence of genetic diseases or disorders, inheritable diseases or disorders, or other common diseases or disorders that have a family history as one of the risk factors, questions regarding any diagnosis of increased risk of any diseases or disorders, and questions concerning wellness-related issues such as a family history of obesity, family history of causes of death, etc. The diseases identified by the survey questions may be related to single-gene diseases or disorders that are caused by a single-nucleotide variant, an insertion, or a deletion. The diseases identified by the survey questions may also be multifactorial inheritance disorders that may be caused by a combination of environmental factors and genes. Examples of multifactorial inheritance disorders may include heart disease, Alzheimer’s disease, diabetes, cancer, and obesity. The computing server 130 may obtain data on a user’s disease-related phenotypes from survey questions about the health history of the user and her family and also from health records uploaded by the user.

Survey questions also may be related to other types of phenotypes such as appearance traits of the users. A survey regarding appearance traits and characteristics may include questions related to eye color, iris pattern, freckles, chin types, finger length, dimple chin, earlobe types, hair color, hair curl, skin pigmentation, susceptibility to skin burn, bitter taste, male baldness, baldness pattern, presence of unibrow, presence of wisdom teeth, height, and weight. A survey regarding other traits also may include questions related to users’ taste and smell such as the ability to taste bitterness, asparagus smell, cilantro aversion, etc. A survey regarding traits may further include questions related to users’ body conditions such as lactose tolerance, caffeine consumption, malaria resistance, norovirus resistance, muscle performance, alcohol flush, etc. Other survey questions regarding a person’s physiological or psychological traits may include vitamin traits and sensory traits such as the ability to sense an asparagus metabolite. Traits may also be collected from historical records, electronic health records and electronic medical records.

The computing server 130 also may present various survey questions related to the environmental factors of users. In this context, an environmental factor may be a factor that is not directly connected to the genetics of the users. Environmental factors may include users’ preferences, habits, and lifestyles. For example, a survey regarding users’ preferences may include questions related to things and activities that users like or dislike, such as types of music a user enjoys, dancing preference, party-going preference, certain sports that a user plays, video game preferences, etc. Other questions may be related to the users’ diet preferences such as like or dislike a certain type of food (e.g., ice cream, egg). A survey related to habits and lifestyle may include questions regarding smoking habits, alcohol consumption and frequency, daily exercise duration, sleeping habits (e.g., morning person versus night person), sleeping cycles and problems, hobbies, and travel preferences. Additional environmental factors may include diet amount (calories, macronutrients), physical fitness abilities (e.g., stretching, flexibility, heart rate recovery), family type (adopted family or not, has siblings or not, lived with extended family during childhood), property and item ownership (has home or rents, has a smartphone or doesn’t, has a car or doesn’t).

Surveys also may be related to other environmental factors such as geographical, social-economic, or cultural factors. Geographical questions may include questions related to the birth location, family migration history, town, or city of users’ current or past residence. Social-economic questions may be related to users’ education level, income, occupations, self-identified demographic groups, etc. Questions related to culture may concern users’ native language, language spoken at home, customs, dietary practices, etc. Other questions related to users’ cultural and behavioral questions are also possible.

For any survey questions asked, the computing server 130 may also ask an individual the same or similar questions regarding the traits and environmental factors of the ancestors, family members, other relatives or friends of the individual. For example, a user may be asked about the native language of the user and the native languages of the user’s parents and grandparents. A user may also be asked about the health history of his or her family members.

In addition to storing the survey data in the individual profile store 210, the computing server 130 may store some responses that correspond to data related to genealogical and genetics respectively to genealogy data store 200 and genetic data store 205.

The user profile data, photos of users, survey response data, the genetic data, and the genealogy data may be subject to the privacy and authorization setting of the users to specify any data related to the users that can be accessed, stored, obtained, or otherwise used. For example, when presented with a survey question, a user may select to answer or skip the question. The computing server 130 may present users from time-to-time information regarding users’ selection of the extent of information and data shared. The computing server 130 also may maintain and enforce one or more privacy settings for users in connection with the access of the user profile data, photos, genetic data, and other sensitive data. For example, the user may pre-authorize the access to the data and may change the setting as wished. The privacy settings also may allow a user to specify (e.g., by opting out, by not opting in) whether the computing server 130 may receive, collect, log, or store particular data associated with the user for any purpose. A user may restrict her data at various levels. For example, on one level, the data may not be accessed by the computing server 130 for purposes other than displaying the data in the user’s own profile. On another level, the user may authorize anonymization of her data and participate in studies and research conducted by the computing server 130 such as a large-scale genetic study. On yet another level, the user may turn some portions of her genealogy data public to allow the user to be discovered by other users (e.g., potential relatives) and be connected to one or more family trees. Access or sharing of any information or data in the computing server 130 may also be subject to one or more similar privacy policies. A user’s data and content objects in the computing server 130 may also be associated with different levels of restriction. The computing server 130 may also provide various notification features to inform and remind users of their privacy and access settings. For example, when privacy settings for a data entry allow a particular user or other entities to access the data, the data may be described as being “visible,” “public,” or other suitable labels, contrary to a “private” label.

In some cases, the computing server 130 may have heightened privacy protection on certain types of data and data related to certain vulnerable groups. In some cases, the heightened privacy settings may strictly prohibit the use, analysis, and sharing of data related to a certain vulnerable group. In other cases, the heightened privacy settings may specify that data subject to those settings require prior approval for access, publication, or other use. In some cases, the computing server 130 may provide heightened privacy as a default setting for certain types of data, such as genetic data or any data that the user marks as sensitive. The user may opt in to sharing those data or change the default privacy settings. In other cases, the heightened privacy settings may apply across the board for all data of certain groups of users. For example, if computing server 130 determines that the user is a minor or has recognized that a picture of a minor is uploaded, the computing server 130 may designate all profile data associated with the minor as sensitive. In those cases, the computing server 130 may have one or more extra steps in seeking and confirming any sharing or use of the sensitive data.

In some embodiments, the individual profile store 210 may be a large-scale data store. In some embodiments, the individual profile store 210 may include at least 10,000 data records in the form of user profiles and each user profile may be associated with one or more inheritance datasets and one or more genealogical data entries. In some embodiments, the individual profile store 210 may include at least 50,000 data records in the form of user profiles and each user profile may be associated with one or more inheritance datasets and one or more genealogical data entries. In some embodiments, the individual profile store 210 may include at least 100000 data records in the form of user profiles and each user profile may be associated with one or more inheritance datasets and one or more genealogical data entries. In some embodiments, the individual profile store 210 may include at least 500000 data records in the form of user profiles and each user profile may be associated with one or more inheritance datasets and one or more genealogical data entries. In some embodiments, the individual profile store 210 may include at least 1,000,000 data records in the form of user profiles and each user profile may be associated with one or more inheritance datasets and one or more genealogical data entries. In some embodiments, the individual profile store 210 may include at least 2,000,000 data records in the form of user profiles and each user profile may be associated with one or more inheritance datasets and one or more genealogical data entries. In some embodiments, the individual profile store 210 may include at least 5,000,000 data records in the form of user profiles and each user profile may be associated with one or more inheritance datasets and one or more genealogical data entries. In some embodiments, the individual profile store 210 may include at least 10,000,000 data records in the form of user profiles and each user profile may be associated with one or more inheritance datasets and one or more genealogical data entries.

The sample pre-processing engine 215 receives and pre-processes data received from various sources to change the data into a format used by the computing server 130. For genealogy data, the sample pre-processing engine 215 may receive data from an individual via the user interface 115 of the client device 110. To collect the user data (e.g., genealogical and survey data), the computing server 130 may cause an interactive user interface on the client device 110 to display interface elements in which users can provide genealogy data and survey data. Additional data may be obtained from scans of public records. The data may be manually provided or automatically extracted via, for example, optical character recognition (OCR) performed on census records, town or government records, or any other item of printed or online material. Some records may be obtained by digitalizing written records such as older census records, birth certificates, death certificates, etc.

The sample pre-processing engine 215 may also receive raw data from the genetic data extraction service server 125. The genetic data extraction service server 125 may perform laboratory analysis of biological samples of users and generate sequencing results in the form of digital data. The sample pre-processing engine 215 may receive the raw inheritance datasets from the genetic data extraction service server 125. Most of the mutations that are passed down to descendants are related to single-nucleotide polymorphism (SNP). SNP is a substitution of a single nucleotide that occurs at a specific position in the genome. The sample pre-processing engine 215 may convert the raw base pair sequence into a sequence of genotypes of target SNP sites. Alternatively, the pre-processing of this conversion may be performed by the genetic data extraction service server 125. The sample pre-processing engine 215 identifies autosomal SNPs in an individual’s inheritance dataset. In some embodiments, the SNPs may be autosomal SNPs. In some embodiments, 700000 SNPs may be identified in an individual’s data and may be stored in genetic data store 205. Alternatively, in some embodiments, an inheritance dataset may include at least 10,000 SNP sites. In another embodiment, an inheritance dataset may include at least 100000 SNP sites. In yet another embodiment, an inheritance dataset may include at least 300000 SNP sites. In yet another embodiment, an inheritance dataset may include at least 1,000,000 SNP sites. The sample pre-processing engine 215 may also convert the nucleotides into bits. The identified SNPs, in bits or in other suitable formats, may be provided to the phasing engine 220 which phases the individual’s diploid genotypes to generate a pair of haplotypes for each user.

The phasing engine 220 phases a diploid inheritance dataset into a pair of haploid inheritance datasets and may perform imputation of SNP values at certain sites whose alleles are missing. An individual’s haplotype may refer to a collection of alleles (e.g., a sequence of alleles) that are inherited from a parent.

Phasing may include a process of determining the assignment of alleles (particularly heterozygous alleles) to chromosomes. Owing to conditions and other constraints in sequencing or microarray, a DNA identification result often includes data regarding a pair of alleles at a given SNP locus of a pair of chromosomes but may not be able to distinguish which allele belongs to which specific chromosome. The phasing engine 220 uses a genotype phasing algorithm to assign one allele to a first chromosome and another allele to another chromosome. The genotype phasing algorithm may be developed based on an assumption of linkage disequilibrium (LD), which states that haplotype in the form of a sequence of alleles tends to cluster together. The phasing engine 220 is configured to generate phased sequences that are also commonly observed in many other samples. Put differently, haplotype sequences of different individuals tend to cluster together. A haplotype-cluster model may be generated to determine the probability distribution of a haplotype that includes a sequence of alleles. The haplotype-cluster model may be trained based on labeled data that includes known phased haplotypes from a trio (parents and a child). A trio is used as a training sample because the correct phasing of the child is almost certain by comparing the child’s genotypes to the parent’s inheritance datasets. The haplotype-cluster model may be generated iteratively along with the phasing process with a large number of unphased genotype datasets. The haplotype-cluster model may also be used to impute one or more missing data.

By way of example, the phasing engine 220 may use a directed acyclic graph model such as a hidden Markov model (HMM) to perform the phasing of a target genotype dataset. The directed acyclic graph may include multiple levels, each level having multiple nodes representing different possibilities of haplotype clusters. An emission probability of a node, which may represent the probability of having a particular haplotype cluster given an observation of the genotypes may be determined based on the probability distribution of the haplotype-cluster model. A transition probability from one node to another may be initially assigned to a non-zero value and be adjusted as the directed acyclic graph model and the haplotype-cluster model are trained. Various paths are possible in traversing different levels of the directed acyclic graph model. The phasing engine 220 determines a statistically likely path, such as the most probable path or a probable path that is at least more likely than 95% of other possible paths, based on the transition probabilities and the emission probabilities. A suitable dynamic programming algorithm such as the Viterbi algorithm may be used to determine the path. The determined path may represent the phasing result. U.S. Patent No. 10,679,729, entitled “Haplotype Phasing Models,” granted on June 9, 2020, describes example embodiments of haplotype phasing.

A phasing algorithm may also generate phasing result that has a long genomic distance accuracy and cross-chromosome accuracy in terms of haplotype separation. For example, in some embodiments, an IBD-phasing algorithm may be used, which is described in further detail in U.S. Patent Application Publication No. US 2021/0034647, entitled “Clustering of Matched Segments to Determine Linkage of Dataset in a Database,” published on February 4, 2021. For example, the computing server 130 may receive a target individual genotype dataset and a plurality of additional individual genotype datasets that include haplotypes of additional individuals. For example, the additional individuals may be reference panels or individuals who are linked (e.g., in a family tree) to the target individual. The computing server 130 may generate a plurality of sub-cluster pairs of first parental groups and second parental groups. Each sub-cluster pair may be in a window. The window may correspond to a genomic segment and has a similar concept of window used in the ethnicity estimation engine 245 and the rest of the disclosure related to HMMs, but how windows are precisely divided and defined may be the same or different in the phasing engine 220 and in an HMM. Each sub-cluster pair may correspond to a genetic locus. In some embodiments, each sub-cluster pair may have a first parental group that includes a first set of matched haplotype segments selected from the plurality of additional individual datasets and a second parental group that includes a second set of matched haplotype segments selected from the plurality of additional individual datasets. The computing server 130 may generate a super-cluster of a parental side by linking the first parental groups and the second parental groups across a plurality of genetic loci (across a plurality of sub-cluster pairs). Generating the super-cluster of the parental side may include generating a candidate parental side assignment of parental groups across a set of sub-cluster pairs that represent a set of genetic loci in the plurality of genetic loci. The computing server 130 may determine the number of common additional individual genotype datasets that are classified in the candidate parental side assignment. The computing server 130 may determine the candidate parental side assignment to be part of the super-cluster based on the number of common additional individual genotype datasets. Any suitable algorithms may be used to generate the super-cluster, such as a heuristic scoring approach, a bipartite graph approach, or another suitable approach. The computing server 130 may generate a haplotype phasing of the target individual from the super-cluster of the parental side.

The IBD estimation engine 225 estimates the amount of shared genetic segments between a pair of individuals based on phased genotype data (e.g., haplotype datasets) that are stored in the genetic data store 205. IBD segments may be segments identified in a pair of individuals that are putatively determined to be inherited from a common ancestor. The IBD estimation engine 225 retrieves a pair of haplotype datasets for each individual. The IBD estimation engine 225 may divide each haplotype dataset sequence into a plurality of windows. Each window may include a fixed number of SNP sites (e.g., about 100 SNP sites). The IBD estimation engine 225 identifies one or more seed windows in which the alleles at all SNP sites in at least one of the phased haplotypes between two individuals are identical. The IBD estimation engine 225 may expand the match from the seed windows to nearby windows until the matched windows reach the end of a chromosome or until a homozygous mismatch is found, which indicates the mismatch is not attributable to potential errors in phasing or imputation. The IBD estimation engine 225 determines the total length of matched segments, which may also be referred to as IBD segments. The length may be measured in the genetic distance in the unit of centimorgans (cM). A unit of centimorgan may be a genetic length. For example, two genomic positions that are one cM apart may have a 1% chance during each meiosis of experiencing a recombination event between the two positions. The computing server 130 may save data regarding individual pairs who share a length of IBD segments exceeding a predetermined threshold (e.g., 6 cM), in a suitable data store such as in the genealogy data store 200. U.S. Patent No. 10,114,922, entitled “Identifying Ancestral Relationships Using a Continuous stream of Input,” granted on October 30, 2018, and U.S. Patent No. 10,720,229, entitled “Reducing Error in Predicted Genetic Relationships,” granted on July 21, 2020, describe example embodiments of IBD estimation.

Typically, individuals who are closely related share a relatively large number of IBD segments, and the IBD segments tend to have longer lengths (individually or in aggregate across one or more chromosomes). In contrast, individuals who are more distantly related share relatively fewer IBD segments, and these segments tend to be shorter (individually or in aggregate across one or more chromosomes). For example, while close family members often share upwards of 71 cM of IBD (e.g., third cousins), more distantly related individuals may share less than 12 cM of IBD. The extent of relatedness in terms of IBD segments between two individuals may be referred to as IBD affinity. For example, the IBD affinity may be measured in terms of the length of IBD segments shared between two individuals.

Community assignment engine 230 assigns individuals to one or more genetic communities based on the genetic data of the individuals. A genetic community may correspond to an ethnic origin or a group of people descended from a common ancestor. The granularity of genetic community classification may vary depending on embodiments and methods used to assign communities. For example, in some embodiments, the communities may be African, Asian, European, etc. In another embodiment, the European community may be divided into Irish, German, Swedes, etc. In yet another embodiment, the Irish may be further divided into Irish in Ireland, Irish who immigrated to America in 1800, Irish who immigrated to America in 1900, etc. The community classification may also depend on whether a population is admixed or unadmixed. For an admixed population, the classification may further be divided based on different ethnic origins in a geographical region.

Community assignment engine 230 may assign individuals to one or more genetic communities based on their inheritance datasets using machine learning models trained by unsupervised learning or supervised learning. In an unsupervised approach, the community assignment engine 230 may generate data representing a partially connected undirected graph. In this approach, the community assignment engine 230 represents individuals as nodes. Some nodes are connected by edges whose weights are based on IBD affinity between two individuals represented by the nodes. For example, if the total length of two individuals’ shared IBD segments does not exceed a predetermined threshold, the nodes are not connected. The edges connecting two nodes are associated with weights that are measured based on the IBD affinities. The undirected graph may be referred to as an IBD network. The community assignment engine 230 uses clustering techniques such as modularity measurement (e.g., the Louvain method) to classify nodes into different clusters in the IBD network. Each cluster may represent a community. The community assignment engine 230 may also determine sub-clusters, which represent sub-communities. The computing server 130 saves the data representing the IBD network and clusters in the IBD network data store 235. U.S. Patent No. 10,223,498, entitled “Discovering Population Structure from Patterns of Identity-By-Descent,” granted on March 5, 2019, describes example embodiments of community detection and assignment.

The community assignment engine 230 may also assign communities using supervised techniques. For example, inheritance datasets of known genetic communities (e.g., individuals with confirmed ethnic origins) may be used as training sets that have labels of the genetic communities. Supervised machine learning classifiers, such as logistic regressions, support vector machines, random forest classifiers, and neural networks may be trained using the training set with labels. A trained classifier may distinguish binary or multiple classes. For example, a binary classifier may be trained for each community of interest to determine whether a target individual’s inheritance dataset belongs or does not belong to the community of interest. A multi-class classifier such as a neural network may also be trained to determine whether the target individual’s inheritance dataset most likely belongs to one of several possible genetic communities.

Reference panel sample store 240 stores reference panel samples for different genetic communities. A reference panel sample is the genetic data of an individual whose genetic data is the most representative of a genetic community. The genetic data of individuals with the typical alleles of a genetic community may serve as reference panel samples. For example, some alleles of genes may be over-represented (e.g., being highly common) in a genetic community. Some inheritance datasets include alleles that are commonly present among members of the community. Reference panel samples may be used to train various machine learning models in classifying whether a target inheritance dataset belongs to a community, determining the ethnic composition of an individual, and determining the accuracy of any genetic data analysis, such as by computing a posterior probability of a classification result from a classifier.

A reference panel sample may be identified in different ways. In some embodiments, an unsupervised approach in community detection may apply the clustering algorithm recursively for each identified cluster until the sub-clusters contain a number of nodes that are smaller than a threshold (e.g., containing fewer than 1000 nodes). For example, the community assignment engine 230 may construct a full IBD network that includes a set of individuals represented by nodes and generate communities using clustering techniques. The community assignment engine 230 may randomly sample a subset of nodes to generate a sampled IBD network. The community assignment engine 230 may recursively apply clustering techniques to generate communities in the sampled IBD network. The sampling and clustering may be repeated for different randomly generated IBD networks for various runs. Nodes that are consistently assigned to the same genetic community when sampled in various runs may be classified as a reference panel sample. The community assignment engine 230 may measure the consistency in terms of a predetermined threshold. For example, if a node is classified to the same community 95% (or another suitable threshold) of the times the node is sampled, the inheritance dataset corresponding to the individual represented by the node may be regarded as a reference panel sample. Additionally, or alternatively, the community assignment engine 230 may select N most consistently assigned nodes as a reference panel for the community.

Other ways to generate reference panel samples are also possible. For example, the computing server 130 may collect a set of samples and gradually filter and refine the samples until high-quality reference panel samples are selected. For example, a candidate reference panel sample may be selected from an individual whose recent ancestors were born at a certain birthplace. The computing server 130 may also draw sequence data from the Human Genome Diversity Project (HGDP). Various candidates may be manually screened based on their family trees, relatives’ birth location, and other quality controls. Principal component analysis may be used to create clusters of genetic data of the candidates. Each cluster may represent an ethnicity. The predictions of the ethnicity of those candidates may be compared to the ethnicity information provided by the candidates to perform further screening.

The ethnicity estimation engine 245 estimates the ethnicity composition of an inheritance dataset of a target individual. The inheritance datasets used by the ethnicity estimation engine 245 may be genotype datasets or haplotype datasets. For example, the ethnicity estimation engine 245 estimates the ancestral origins (e.g., ethnicity) based on the individual’s genotypes or haplotypes at the SNP sites. To take a simple example of three ancestral populations corresponding to African, European and Native American, an admixed user may have nonzero estimated ethnicity proportions for all three ancestral populations, with an estimate such as [0.05, 0.65, 0.30], indicating that the user’s genome is 5% attributable to African ancestry, 65% attributable to European ancestry and 30% attributable to Native American ancestry. The ethnicity estimation engine 245 generates the ethnic composition estimate and stores the estimated ethnicities in a data store of computing server 130 with a pointer in association with a particular user.

In some embodiments, the ethnicity estimation engine 245 divides a target inheritance dataset into a plurality of windows (e.g., about 1000 windows). Each window includes a small number of SNPs (e.g., 300 SNPs). The ethnicity estimation engine 245 may use a directed acyclic graph model to determine the ethnic composition of the target inheritance dataset. The directed acyclic graph may represent a trellis of an inter-window hidden Markov model (HMM). The graph includes a sequence of a plurality of node groups. Each node group, representing a window, includes a plurality of nodes. The nodes represent different possibilities of labels of genetic communities (e.g., ethnicities) for the window. A node may be labeled with one or more ethnic labels. For example, a level includes a first node with a first label representing the likelihood that the window of SNP sites belongs to a first ethnicity and a second node with a second label representing the likelihood that the window of SNPs belongs to a second ethnicity. Each level includes multiple nodes so that there are many possible paths to traverse the directed acyclic graph.

The nodes and edges in the directed acyclic graph may be associated with different emission probabilities and transition probabilities. An emission probability associated with a node represents the likelihood that the window belongs to the ethnicity labeling the node given the observation of SNPs in the window. The ethnicity estimation engine 245 determines the emission probabilities by comparing SNPs in the window corresponding to the target inheritance dataset to corresponding SNPs in the windows in various reference panel samples of different genetic communities stored in the reference panel sample store 240. The transition probability between two nodes represents the likelihood of transition from one node to another across two levels. The ethnicity estimation engine 245 determines a statistically likely path, such as the most probable path or a probable path that is at least more likely than 95% of other possible paths, based on the transition probabilities and the emission probabilities. A suitable dynamic programming algorithm such as the Viterbi algorithm or the forward-backward algorithm may be used to determine the path. After the path is determined, the ethnicity estimation engine 245 determines the ethnic composition of the target inheritance dataset by determining the label compositions of the nodes that are included in the determined path. U.S. Patent No. 10,558,930, entitled “Local Genetic Ethnicity Determination System,” granted on February 11, 2020, and U.S. Patent No. 10,692,587, granted on June 23, 2020, entitled “Global Ancestry Determination System” describe different example embodiments of ethnicity estimation.

The tree management engine 250 performs computations and other processes related to users’ management of their data trees such as family trees. The tree management engine 250 may allow a user to build a data tree from scratch or to link the user to existing data trees. In some embodiments, the tree management engine 250 may suggest a connection between a target individual and a family tree that exists in the family tree database by identifying potential family trees for the target individual and identifying one or more most probable positions in a potential family tree. A user (target individual) may wish to identify family trees to which he or she may potentially belong. Linking a user to a family tree or building a family may be performed automatically, manually, or using techniques with a combination of both. In an embodiment of an automatic tree matching, the tree management engine 250 may receive an inheritance dataset from the target individual as input and search related individuals that are IBD-related to the target individual. The tree management engine 250 may identify common ancestors. Each common ancestor may be common to the target individual and one of the related individuals. The tree management engine 250 may in turn output potential family trees to which the target individual may belong by retrieving family trees that include a common ancestor and an individual who is IBD-related to the target individual. The tree management engine 250 may further identify one or more probable positions in one of the potential family trees based on information associated with matched genetic data between the target individual and those in the potential family trees through one or more machine learning models or other heuristic algorithms. For example, the tree management engine 250 may try putting the target individual in various possible locations in the family tree and determine the highest probability position(s) based on the inheritance dataset of the target individual and inheritance datasets available for others in the family tree and based on genealogy data available to the tree management engine 250. The tree management engine 250 may provide one or more family trees from which the target individual may select. For a suggested family tree, the tree management engine 250 may also provide information on how the target individual is related to other individuals in the tree. In a manual tree building, a user may browse through public family trees and public individual entries in the genealogy data store 200 and individual profile store 210 to look for potential relatives that can be added to the user’s family tree. The tree management engine 250 may automatically search, rank, and suggest individuals for the user conduct manual reviews as the user makes progress in the front-end interface 260 in building the family tree.

As used herein, “pedigree” and “family tree” may be interchangeable and may refer to a family tree chart or pedigree chart that shows, diagrammatically, family information, such as family history information, including parentage, offspring, spouses, siblings, or otherwise for any suitable number of generations and/or people, and/or data pertaining to persons represented in the chart. U.S. Patent No. 11,429,615, entitled “Linking Individual Datasets to a Database,” granted on August 30, 2022, describes example embodiments of how an individual may be linked to existing family trees.

The front-end interface 260 may render a front-end platform that displays various results determined by the computing server 130. The platform may take the form of a genealogy research and family tree building platform and/or a personal DNA data analysis platform. The platform may also serve as a social networking system that allows users and connect and build family trees and research family relations together. The results and data may include the IBD affinity between a user and another individual, the community assignment of the user, the ethnicity estimation of the user, phenotype prediction and evaluation, genealogy data search, family tree and pedigree, relative profile and other information. The front-end interface 260 may allow users to manage their profile and data trees (e.g., family trees). The users may view various public family trees stored in the computing server 130 and search for individuals and their genealogy data via the front-end interface 260. The computing server 130 may suggest or allow the user to manually review and select potentially related individuals (e.g., relatives, ancestors, close family members) to add to the user’s data tree. The front-end interface 260 may be a graphical user interface (GUI) that displays various information and graphical elements.

The front-end interface 260 may take different forms. In one case, the front-end interface 260 may be a software application that can be displayed on an electronic device such as a computer or a smartphone. The software application may be developed by the entity controlling the computing server 130 and be downloaded and installed on the client device 110. In another case, the front-end interface 260 may take the form of a webpage interface of the computing server 130 that allows users to access their family tree and genetic analysis results through web browsers. In yet another case, the front-end interface 260 may provide an application program interface (API). In some embodiments, the front-end interface 260 may be rendered as part of the content in an extended reality device, such as a head-mounted display or a phone camera that is integrated with augmented reality features.

The front-end interface 260 may provide various front-end visualization features. In some embodiments, a family tree viewer may render family tree built by users and/or managed by the tree management engine 250. The family tree may be displayed in a nested nodes and edges connected based on family relationships or genetic matches determined by various genetic data analysis engines discussed in FIG. 2. The family trees may include attached records that are part of records in the genealogy data store 200, including records that are uploaded by users and gallery images. The user may assign a focal person to a family tree and the family tree is displayed with the focus (such as positioning the focal person at the center or relative prominent position of the tree) around the focal person. A user may change the focal person and the family tree may shift accordingly based on the relationships and relative positions of members in the family tree. Each person in the family tree may be associated with historical photos from gallery images, historical genealogy records such as life event records, one or more stories and live events associated with the person, and metadata such as family relationships and other family trees associated with the person.

In some embodiments, visualization features provided by the front-end interface 260 may include a map feature. A map may be a geographical map that may take the form of a digital map, a historical physical map, and/or a historical map overlaid on a digital map. A user may select a geographical location and the front-end interface 260 displays relevant genealogical or genetic records associated with the location, such as an ancestor’s lifetime events, birth locations of DNA matches, mitigation patterns of ancestors across different locations over time and associated genealogical records, residence maps that provide specific locations of historical persons’ events, and historical maps overlaying on a digital map to contextualize ancestors’ records and events. The map feature may also provide interactive features to allow users to view historical documents, photographs, and stores associated with the geographical locations. The map feature may also allow users to adjust timeframes, displaying changes in locations and migrations over different periods.

In some embodiments, visualization features provided by the front-end interface 260 may include a story feature that provides multimedia narratives about a person, such as the person’s live events and family history. The story feature allows a user to compile various graphical and genealogical elements such as photos, documents, historical records, and personal anecdotes into a timeline to summarize a narrative. The story may be arranged in an appropriate spatial manner such as a linear arrangement that arranges various graphical elements based on the creator’s selection.

In this disclosure, a genetic data may be an example of inheritance data. An individual is an example of a named entity. A genetic sequence is an example of data string or bit string. A genetic segment is an example of data string segment. A matched genetic segment is an example of matched data string. For example, an IBD segment is an example of a matched data string segment. An ethnicity is an example or a data origin or a data classification. A phenotype, or a phenotypic trait, is an example of a data manifestation, and both “phenotype” and “phenotypic trait” are used interchangeably herein. A reproductive event is an example of a data inheritance event.

The content extraction engine 265 may provide a multi-stage process for extracting content from historical physical documents. For example, the content extraction engine 265 may use and train a machine learning model for extracting structured data from images of historical physical documents. In some examples, the record management system 102 can include the content extraction engine 265 or the content extraction engine 265 can be an example of the record management system 102.

### Extracting Content from Historical Physical Documents

A fine-tuned machine learning model can be used to extract content from images of historical physical documents that include handwriting and names. The names can be difficult to predict in terms of the next token because first name and last name might not have any correlation. In the training data, the records can be first converted into a structured markup format to increase the predictability of tokens. A bounding box component can be added to the transformer to correlate a bounding box to one or more tokens. There may be more tokens than the number of bounding boxes. For example, a first name can be a token, a last name can be a token, and both tokens may belong to the same bounding box. In training, a bounding box can be masked and tokens that generate the worst or largest error will be likely associated with the masked box because the error is high when the box is masked. By training an association between bounding boxes and tokens, inference can be made to effectively extract records from documents.

### Receive an input image of a document

The content extraction engine 265 can receive an input image of a historical physical document. This image can be a scanned or otherwise digitized version of a handwritten or typed document, such as a genealogical record. The input image can be a standard digital format like JPEG or PNG. The input image can contain various types of information such as text, tables, or other structured data. The content extraction engine 265 can process these images and extract meaningful information from them.

### Divide the input image into a plurality of sections

Responsive to receiving the input image, the content extraction engine 265 can divide the input image into multiple sections. In some embodiments, the division into multiple sections can be based on a grid system, where the content extraction engine 265 splits the image into equal-sized rectangles or other suitable shapes. In some embodiments, the content extraction engine 265 may use other methods that take into account the layout of the document. For instance, if the document has clear columns or sections, the division may align with these natural boundaries.

### Generate encoded image features.

The content extraction engine 265 can apply a first machine learning model, (e.g., a transformer such as but not limited to a Shifted Window Transformer transformer) to the plurality of sections of the input image to generate encoded image features. This step may include feeding patches or sections of the image into the first machine learning model. The transformer is, in embodiments, a vision encoder that processes the input image in a hierarchical manner. It can divide the image into non-overlapping windows and apply self-attention within these windows, then shifts the window partitioning between consecutive layers. This approach may allow the model to capture both local and global features of the input image efficiently. The output of this process may be a set of encoded image features, which represent high-level abstractions of the visual information contained in each section of the input image. These encoded features can capture important aspects of the layout, structure, and content of the input image, preparing the data for subsequent steps in the extraction process.

### Generate a sequence of tokens

The content extraction engine 265 may use a second machine learning model (e.g., a transformer decoder) to generate a sequence of tokens representing text and structural information from the encoded image features. The second machine learning model may take the encoded states and hidden states from the first machine learning model as input. The second machine learning model can generate tokens progressively, using both the encoded image features and previously predicted tokens (e.g. predicted by the second machine learning model for the inputted encoded states and hidden states of previous sections of the input image) to determine each new token. The output can be represented in a custom markup language format that includes record-level tags, field-level tags, and content tokens. For example, a token might represent a sub-word unit, a full word, or a special markup tag like “<record>” to indicate the start of a new record. The markup language format can be designed to capture both the textual content and the structural information of the document, such as field names and record boundaries. This approach can allow the model to understand and represent the hierarchical nature of the document's content, making it easier to extract structured data in subsequent steps. That is, by providing the custom market language format that incorporates record-start events, the approach of disclosed embodiments is able to generate tokens corresponding to components of an input image, such as distinct articles within a newspaper page or person-specific entries in a Census record, a level of discretization that existing modalities cannot provide.

### Predict a token-level area (or region) associated with each generated token

The content extraction engine 265 may use a third machine learning model (e.g., a detection transformer (DETR) head) to predict a token-level area associated with each generated token. The third machine learning model may be added to the second machine learning model (i.e., the transformer decoder) and use the second machine learning model's hidden states to determine the area in the image where each token is found. The third machine learning model may output four values for each token, representing the center x-coordinate, center y-coordinate, width, and height of the predicted token-level area. These areas can indicate the spatial location of each token within the original input image. This step can be used for linking the extracted textual information with its position in the document for tasks like highlighting relevant sections in a downstream user interface. This has been found to advantageously provide a consumer-friendly output from the approach, as the user may be able to not only receive the predicted tokens, e.g. a prediction of a handwritten Census entry corresponding to an ancestor, but also to see, within the original document, where that ancestor’s information was originally memorialized, thereby facilitating a more-informative and -emotionally engaging experience for the user.

### Generate a bounding box that includes a plurality of token-level areas

The content extraction engine 265 can generate a bounding box by combining multiple token-level areas. This process can include aggregating the areas of individual tokens that belong to the same field or record. For example, if a name field includes multiple tokens (e.g., corresponding to first name and last name), their individual areas can be combined to create a single bounding box. This step can use the structural information provided by the markup language format, which indicates which tokens belong to the same record. Record, as used herein, may refer to a single portion of a document that corresponds to a single named entity, such as a row of a Census document or an article in a newspaper, or to an entire document, as applicable. Thus, for example, an entirety of a row of a Census document, which may span a plurality of individual boxes or sections with the original document and comprise different tokens corresponding to different sections, may be rejoined by the approach of disclosed embodiments such that a consolidated bounding box corresponding to all of the fields that contain information about a particular named entity or set of related named entities may be generated, facilitating more-convenient viewing and interpretation of the information by a downstream consumer thereof.

### Select one of the token-level areas

The content extraction engine 265 can randomly select one of the token-level areas within the generated bounding box. Different areas can be masked to test the model's understanding of the document structure.

### Mask the selected token-level area

The randomly selected token-level area can be masked or blurred. The masking process can hide the information in that specific region of the image. This step can allow the model to learn the importance of different regions in the document.

### Generate a masked bounding box that includes the selected masked token-level area

Based on the original bounding box, the content extraction engine 265 can generate a new masked bounding box that includes the masked token-level area. For example, the content extraction engine 265 can generate a masked image (e.g., the original image having the masked portion hidden or obscured). The content extraction engine 265 can input the masked image to a machine learning model (e.g., a fourth machine learning model) to generate a prediction in accordance with one or more embodiments described herein (e.g., the prediction can include predicted tokens from using the masked image as an input). In some cases, the masked bounding box can represent the document with a portion of its content hidden, simulating scenarios where parts of the document might be obscured or damaged.

Input the masked bounding box into a fourth machine learning model to generate a prediction of the bounding box

The content extraction engine 265 can input the masked bounding box (e.g., the image with the masked portion) into a fourth machine learning model (e.g., an additional model or a different configuration of the DETR head) to generate a prediction. The fourth machine learning model can be tuned to refine the bounding box predictions based on the masked input.

### Compare the prediction with another value based on the markup language format

The content extraction engine 265 can compare the fourth machine learning model’s prediction for the masked area (or region) with another value based on the markup language format. For example, the content extraction engine 265 can compare the prediction for the masked area (or region) with a prediction generated by using the original image (e.g., the image without any masking), which can be referred to as a contrastive learning approach. A higher loss (greater difference between prediction and expected value) can indicate a stronger association between the masked region and the corresponding text tokens. Stated alternatively, the content extraction engine 265 can build the correlation between the masked region and a token that changes the most between the prediction using the masked image and the prediction using the original image. This comparison can help confirm the correctness of the bounding box boundaries and improves the machine learning model's understanding of the document structure.

Some of the above paragraphs (e.g., paragraphs - ) describe the weakly supervised/contrastive learning training approach, i.e. how to find the correlation between the bounding box proposal and token. As a contrast, a supervised approach uses bounding box ground truth to train the third model in engine 265. The bounding box ground truth can contain the correlation information between the bounding box and token. It can skip the correlation finding steps in -, and calculate the losses in by leveraging the correlation in the ground truth.

### Update parameters of the bounding box

The content extraction engine 265 can update the parameters of the bounding box based on the comparison between the model’s prediction and the expected value. This process can include calculating multiple loss functions, including Generalized Intersection over Union (GIOU) loss, L1 loss, and cross-entropy loss. The GIOU loss can measure the overlap between the predicted and ground-truth bounding boxes, while the L1 loss can compare the coordinates directly. The cross-entropy loss can be used for text-based predictions. These losses can be combined and used to optimize the machine learning model parameters through backpropagation. This step can be desired for fine-tuning the model's ability to accurately predict bounding boxes and their associations with specific tokens or fields. By iteratively updating the parameters based on these comparisons, the machine learning model can learn to better align its predictions with the expected outputs, improving its overall performance in extracting structured data from document images.

### Training machine learning models

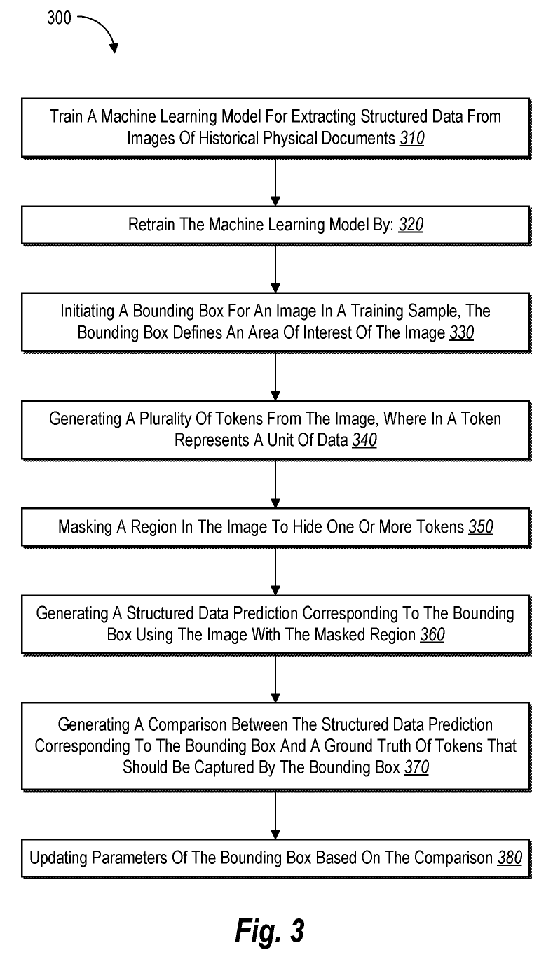

FIG. 3 is a flowchart depicting an example process 300 for training a machine learning model that extracts structured data from images of historical physical documents. The process 300 may be performed by one or more engines of the computing server 130 illustrated in FIG. 2, such as the content extraction engine 265. The process 300 may be embodied as a software algorithm that may be stored as computer instructions that are executable by one or more processors. The instructions, when executed by the processors, cause the processors to perform various steps in the process 300. In various embodiments, the process 300 may include additional, fewer, or different steps. While various steps in the process 300 may be discussed with the use of computing server 130, each step may be performed by a different computing device. FIG. 3. Step 320 is not mentioned in context. In addition, we can add an arrow from step 320 directly to step 380 to represent supervised training for DETR head (if we decide to include the supervised approach).

In some embodiments, the computing server 130 can train a set of machine learning models for extracting structured data from images of historical physical documents through a multi-step process (step 310). The computing server 130 can combine a first machine learning model (e.g., a transformer) as a vision encoder with a second machine learning model (e.g., a transformer decoder) for text generation. The training process can include feeding the models with a large dataset of historical document images along with their corresponding ground truth structured data in a custom markup language format.

The first machine learning model can be trained to process the input images and generate encoded image features. This process teaches the first machine learning model to capture both local and global visual characteristics of the documents, including layout and structural information. Simultaneously, the second machine learning model can be trained to generate sequences of tokens representing the document's content and structure based on these encoded features.

The computing server 130 can train a third machine learning model (e.g., a DETR head) to predict bounding boxes for each generated token, linking the textual content to its spatial location in the original image. The third machine learning model can be trained end-to-end using a combination of loss functions, including cross-entropy loss for token prediction and specialized losses (such as GIOU loss and L1 loss) for bounding box prediction. This training approach can allow the model to learn not only to transcribe the text but also to understand the document's structure and layout for extracting structured data therefrom.

In some embodiments, the computing server 130 can retrain the set of machine learning models (step 310).

The computing server 130 can retrain the set of machine learning models through an iterative process that refines the models’ ability to extract structured data and predict accurate bounding boxes (step 310). This retraining process can include several steps.

First, the computing server 130 can initiate a bounding box for an image in a training sample (step 330). The bounding box can define an area of interest of the image. The computing server 130 can generate tokens from the image (step 340). The computing server 130 can process the image using a first machine learning model (e.g., a vision encoder) to generate encoded image features. The computing server 130 can input the encoded image features into a second machine learning model (e.g., a text decoder). The second machine learning model can generate a sequence of tokens representing text and structural information from the encoded image features, which can be received by the computing server 130. Each token can represent a sub-word unit, a word unit, or a special markup tag. The sequence of tokens can be represented in a custom markup language format. The markup language format can include record-level tags, field-level tags, and content tokens. Each token prediction can be determined based on the encoded image features and previously generated tokens.

The computing server 130 can use a masking technique where a region in the image is masked to hide one or more tokens (step 350).

The computing server 130 can generate structured data prediction corresponding to the bounding box using the image with the masked region (step 360). In one approach, the computing server 130 can input the image with the masked region into the third machine learning model. Subsequently, the computing server 130 can receive, from the third machine learning model, a sequence of tokens in a markup language format. This markup language format can include record-level tags defining individual records, field-level tags defining specific fields within each record, and content tokens representing the extracted text. Utilizing this information, the computing server 130 can predict an associated bounding box for each generated token. This process can allow the server to extract structured data from the document while maintaining spatial awareness of each piece of information within the original image.

The computing server 130 can generate a comparison between the structured data prediction corresponding to the bounding box and a ground truth of tokens that should be captured by the bounding box (step 370). In one approach, the computing server 130 can generate a comparison between the structured data prediction corresponding to the bounding box and a ground truth of tokens that should be captured by the bounding box. This comparison can include calculating a loss function that compares the predicted tokens with the ground truth tokens. The loss function can be implemented such that a higher loss value indicates a stronger association between the masked region and the corresponding text tokens. This relationship can mean the prediction result deteriorates more noticeably when the correct data is masked. Consequently, this deterioration in prediction accuracy can serve as a confirmation of the correctness of the bounding box boundary. This approach can allow the model to learn the importance of different regions in the document and their relationships to the overall structure, even without explicit bounding box annotations for every element.

The computing server 130 can update parameters of the bounding box based on the comparison (step 380). After comparing the predicted structured data with the ground truth, the computing server 130 can use the calculated loss to adjust the bounding box parameters to improve the accuracy of the bounding box in capturing the correct tokens. For example, if the loss is high, indicating a significant discrepancy between prediction and ground truth, the computing server 130 can adjust the position, size, or shape of the bounding box. Updating parameters based on comparison results can allowing the machine learning model to progressively refine its ability to accurately locate and extract structured data from the document image.

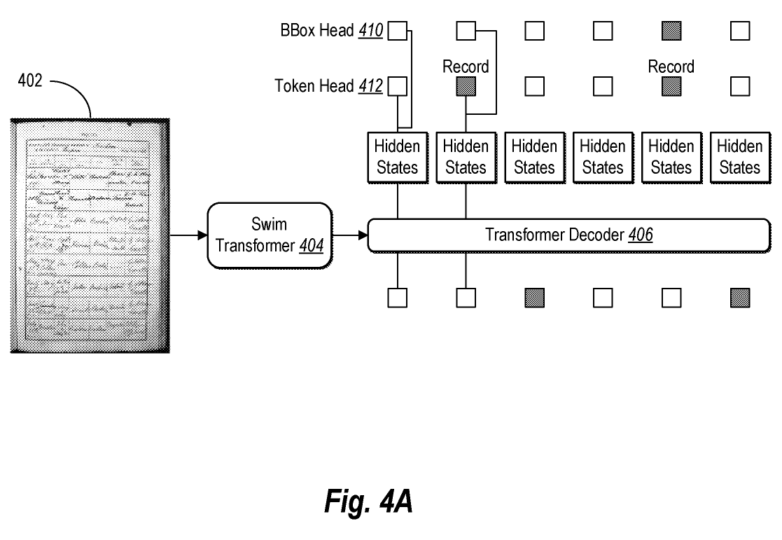

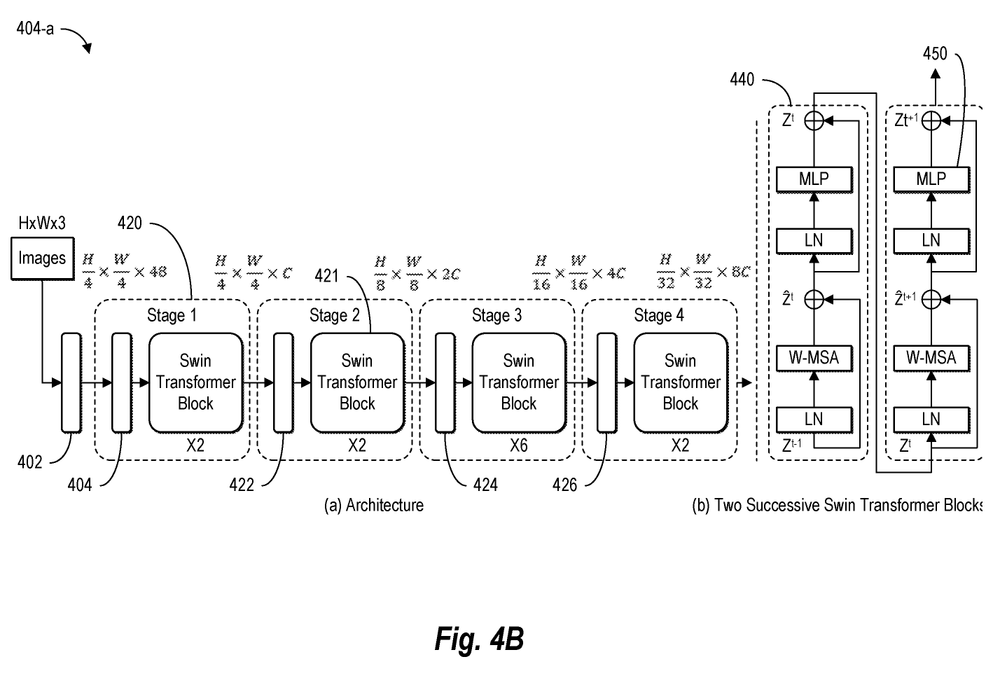

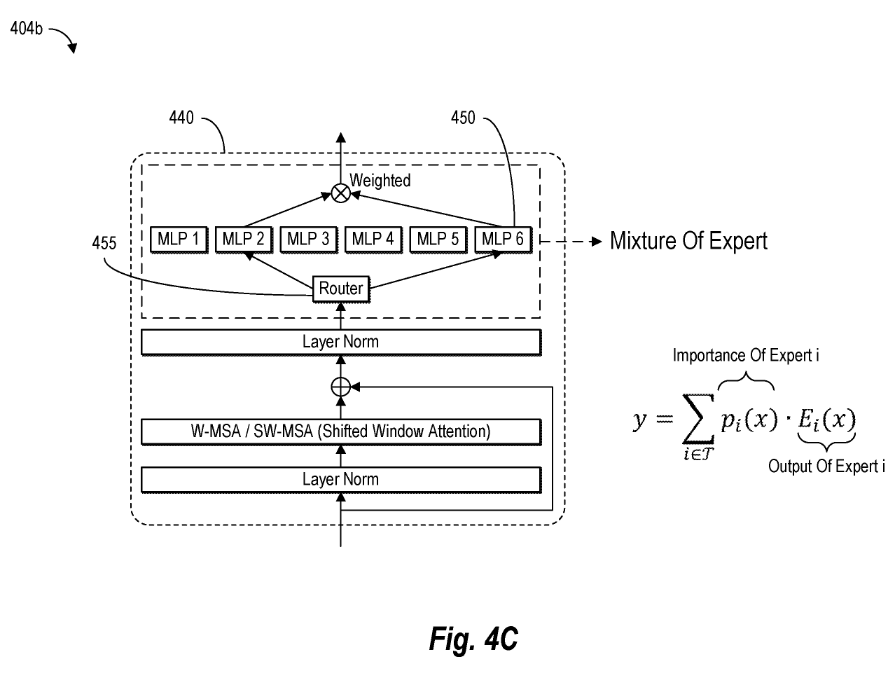

FIG. 4A illustrates an overview of the content extraction and training architecture. An image 402 of a physical document is input into a first machine learning model 404 (the transformer) followed by a second machine learning model 406 (the transformer decoder). A bounding box head 410 and a token head 412 are generated, both of which utilize the same decoder hidden states to predict objects. The token head can generate objects with C channels (where C is the vocabulary size), while the bounding box head can generate objects with four channels representing the center x, center y, width, and height of each bounding box. These objects can be paired one-to-one, allowing each bounding box object to represent the spatial location of its corresponding token object. The machine learning models can use special tokens like “<record>” and “FIELD_NAME-FIELD_VALUE” to denote the beginning of records and fields. During training, the machine learning models can select only the box objects paired with record indicators, calculating box GIOU loss, box L1 loss, and class cross-entropy loss, which are then summed before backpropagation. Unlike DETR, which uses a matching algorithm based on box similarity, this method can select predictions based on paired tokens, employing a novel “fake matcher” approach. This architecture can allow the model to simultaneously extract textual content and predict accurate bounding boxes for structured data in historical documents.

FIG. 4B illustrates an architecture of the first machine learning model 404, which in embodiments is or comprises a transformer model. The transformer model 404 may include one or more transformer blocks 420, comprising, in embodiments, a transformer block 421 and a patch-merging layer (e.g., the first stage can have a patch-merging layer 404, the second stage can have a patch merging layer 422, the third stage can have a patch merging layer 424, and the fourth stage can have a patch merging layer 426). Individual transformer blocks 421 may comprise an arrangement 440 comprising, in embodiments, one or more LayerNorm (LN) modules, a window-based multi-head self-attention (W-MSA) module, a multilayer perceptron (MLP) module 450 which may be a two-layer MLP, or other components or arrangements as suitable. In some examples, the architecture includes a patch partition layer 402. While a shifted-windows arrangement of subsequent transformer blocks has been shown in FIG. 4B, it will be appreciated that any suitable number, arrangement, or variety of architectures may be used.

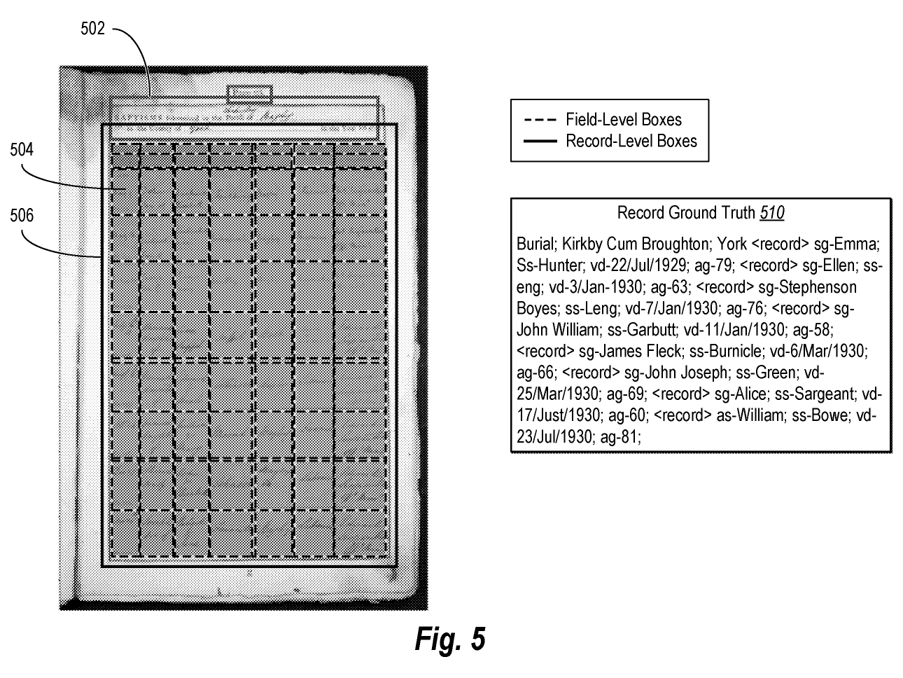

In some embodiments, FIG. 5 illustrates training a machine learning model using images with bounding box proposals (e.g., 502, 504, and 506) and record ground truth 510. The bounding box proposals can be generated by object detection or layout models, such as a table transformer. These proposals can serve as initial guesses for the locations of fields and records in the document. The record ground truth 510 can provide the correct textual content and structure of the information included in the image, but without precise bounding box annotations. The record ground truth 510 can be represented in a markup language format.

The record ground truth can be represented in a custom markup language format, such as “Baptism; Horsham; Sussex <record> sg-Albert Edward; ss-Hoad; vd-5/Oct/1879; g-F; fn-Henry Truster/Hoad; mn-Eliza Mary/Hoad.” The record ground truth can include record-level tags (e.g., <record>), field-level tags (e.g., sg- for given name, ss- for surname, vd- for vital date), or content tokens representing the actual text. The machine learning model can learn to associate the correct textual content with the most appropriate bounding box proposals through the masking and prediction process described in the present disclosure. This method can allow the model to learn to predict accurate bounding boxes without requiring expensive and time-consuming manual annotations for every field and record in the training data.

Additionally or alternatively, FIG. 5 can illustrate bounding box groups generated in accordance with one or more embodiments described herein. For example, the record management system 102 can generate bounding boxes and aggregate the boxes into bounding box groups that correspond to fields of the document depicted in FIG. 5, records of the document depicted in FIG. 5, or other entities of the document. To illustrate, FIG. 5 includes dashed boxes 504 showing “fields” of the document (e.g., a name field, a date field, or other fields represented in the record ground truth 510). FIG. 5 also includes solid boxes 502 and 506. The solid box 506 can indicate one or more “records” of the document (e.g., a record field in the record ground truth 510).

While shown as indicating all of the records in the image of the document, the solid box 506 can instead indicate a single record (e.g., a single row in the record ground truth that corresponds to an entity such as a row for Emma Hunter including associated name fields, date, fields, age fields, etc.). Further, there may be multiple solid boxes 506 for multiple records in the document. For example, each solid box 506 of multiple boxes can correspond to a different record in the image. Additionally or alternatively, FIG. 5 can include a solid box 502 indicating other entity information in the document. For example, the solid box 502 can indicate a document title or type (e.g., the image of the document is a baptism record document).

While shown as dashed boxes 504 and solid boxes 502 and 506 for illustrative clarity, it is to be understood that any style or scheme can be used. For example, the boxes can be color-coded as described herein to show that the box corresponds to an entity (e.g., red can show a field level box annotation, green can show a record level box annotation, and yellow can show other entity information such as a title of the document, etc.). For instance, the dashed boxes 504 can have a first type of depiction (e.g., a first color, dashed boxes, or other style, color, or shape) and the solid boxes 502 and 506 can have a second type of depiction (e.g., a second color, solid boxes, or other style, color, or shape).

### Mixture of Experts for Content Extraction

As suggested above, there is a challenge with properly structuring data that can come from a variety of sources and represent a variety of different types of records using a single approach or pipeline; however, providing a plurality of pipelines configured to specially handle a particular record type or source is architecturally complex and costly to operate. Moreover, such an approach would still be vulnerable to issues resulting from misclassification of record types and processing of the same using a model pipeline ill-suited to that record type.

In embodiments of the current disclosure, a Mixture of Experts approach may be utilized to extract content from documents of a plurality of, or even all, record types, without the aforementioned problem of duplication of model pipelines. Rather, a single model pipeline may be configured, in embodiments, to generate structured data from a variety of inputs.

The Mixture of Experts approach of embodiments may include transformers modified to incorporate a plurality of “experts,” as shown in FIG. 4C. That is, in embodiments, a Mixture of Experts approach may be applied to an encoder component of above-described embodiments of the disclosure. As shown in and described regarding FIG. 4B, a transformer block of the first machine learning model 404 may include an MLP, such as a two-layer MLP, in arrangement with a “LayerNorm” or “Layer Norm” (LN) module(s) and/or window-based multi-head self-attention (W-MSA) module(s). By contrast, in embodiments and as shown in FIG. 4C, one or more transformer blocks of the first machine learning model 404 may utilize a Mixture of Experts arrangement comprising a plurality of MLPs 450 in combination with a router 455. The router 455 may be configured and/or trained to receive, from an upstream LN module, one or more features representing tokens, and then provide said features to a specific one of the plurality of MLPs 450 as suitable. In embodiments, the router 455 may route particular features corresponding to particular components of documents, such as paragraphs as opposed tables, to a particular MLP of the plurality of MLPs 450. In other embodiments, as described below, a load-balancing process may be implemented, ensuring a substantially balanced distribution between the experts, i.e. the plurality of MLPs 450.

It has been found that parameter-efficient fine-tuning may be utilized to free up space on a processor, e.g., a GPU, to scale up input images to a resolution suitable for input to the model as a preprocessing step.

In other embodiments, additional experts may be provided in an attention-specific module of the machine learning model.

A Mixture of Experts implementation of embodiments of the disclosure may include a load-balancing loss implementation as a loss function that measures how much the workload of the experts of the Mixture of Experts is distributed among the experts. Load balancing may include determining a distribution of usage of experts; for example, when providing a batch of samples to the model, the experts should handle the samples in substantially even proportion relative to each other. The experts process tokens corresponding to different types of content of records, such as tables, paragraphs, images, etc. Since record images are usually a combination of patches of different types of tokens (corresponding to content types like paragraphs, lists, etc.), the experts of the Mixture of Experts can be configured to receive as input the tokens from the record images that correspond to those content types.

It has been surprisingly found that the use of a Mixture of Experts approach improves the performance of a content extraction modality such as those of embodiments of the disclosure. Further, it has further been surprisingly found that, whereas Mixture of Experts has only previously been applied to text-based inputs and chatbot-specific applications, the image-based content extraction modalities of the present disclosure were successful in implementing Mixture of Experts on image inputs, particularly record-type inputs, and in a manner that improved performance overall. It has further been surprisingly found that implementing Mixture of Experts with token-based inputs allows for improved performance of the model.

As used herein, the term “machine learning model” can refer to a computer algorithm or a collection of computer algorithms that automatically improve for a particular task through iterative outputs or predictions based on use of data. For example, a machine learning model can utilize one or more learning techniques to improve in accuracy and/or effectiveness. Example machine learning models include various types of neural networks, decision trees, support vector machines, and Bayesian networks. In some embodiments, the record management system 102 utilizes machine learning model in the form of a neural network.

Relatedly, as used herein, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., responses, data for passing to downstream models, and/or records) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, a transformer neural network, or a generative adversarial neural network.

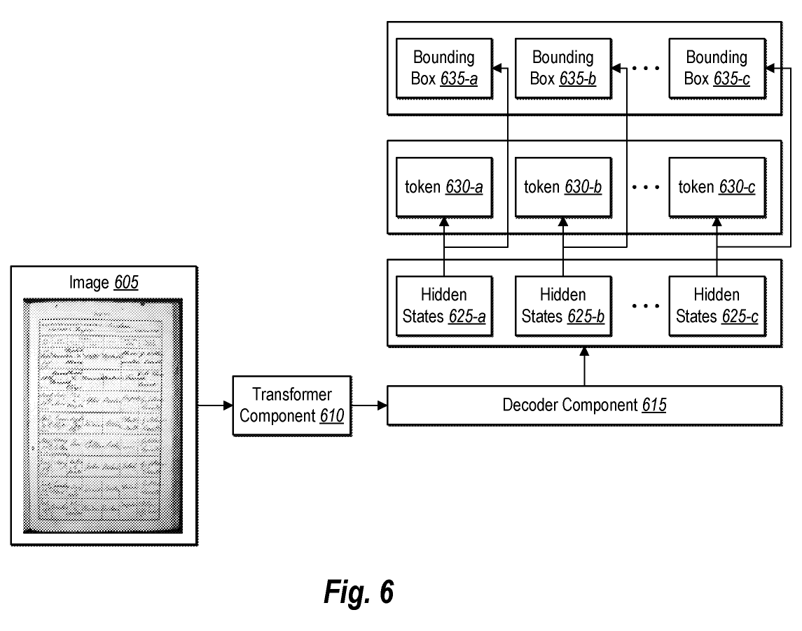

As used herein, the term “record generation model” can refer to one or more machine learning models for generating records, fields, bounding boxes, or a combination thereof. For example, a record generation model can be an example of a machine learning model with one or more components as described herein (e.g., the record generation model can include a transformer component, a decoder component, and one or more head components as described herein with reference to FIG. 6). Additionally or alternatively, components of the record generation model can be examples of machine learning models. For example, the record generation model can include multiple machine learning models as described herein with reference to FIG. 2.

As used herein, the term “genealogical record” (or sometimes simply “record”) can refer to a digital object or a digital file that includes information (e.g., genealogical information) interpretable by a computing device (e.g., a client device) or a genealogical data system to present information to a user. In some examples, a record can constitute a data object recognizable by a genealogical data system and that includes information associated with a particular entity. As an illustrative example, a record can include or indicate one or more fields of information that are associated with an individual or other entity in a document. Relatedly, as used herein the term “field” can refer to information associated with an entity that is included in a record. To illustrate, a document can include information for one or more individuals (e.g., a burial record including rows listing names, burial dates, ages, and the like). The document can be an example of a record or can include one or more records. For instance, each row in the document can be an example of a “record” associated with a particular entity. Further, each row can include one or more fields. To illustrate, a record associated with an entity (e.g., “John Smith”) can include a name field indicating a name of the entity, an age field indicating an age of the entity, a date field indicating a date associated with the record, etc.

A record can include a file such as a digital text file, a digital image file, a digital audio file, a webpage, a website, a digital video file, a web file, a link, a digital document file, or some other type of file or digital object. A record can have a particular file type or file format, which may differ for different types of digital records (e.g., digital documents, digital images, digital videos, or digital audio files). In some cases, a record can refer to a genealogical record that includes or depicts historical or genealogical information, such as a birth certificate, a digitized newspaper article, a digitized photograph of a relative, a digitized census record, a digitized obituary, a digitized court document, a digitized DNA analysis, or a digitized family tree. In some embodiments, a genealogical record includes a record selected or identified to surface to a client device, such as an item in a response, a record hint (e.g., a stored or generated genealogical record surfaced as a suggestion for a user account), a digital story (e.g., a stored collection of genealogical records arranged for a particular person, topic, or entity of a genealogical-data system), a digital image (e.g., a digitized photograph), a new person hint (e.g., a suggested node to add to a genealogical tree), a member tree hint (e.g., a prediction for correcting a node within a genealogical tree of a user account), or a DNA match (e.g., a record indicating a DNA match of a user account to a relative whose information is stored in a genealogical-data system).

As used herein, the term “bounding box” can refer to a digital representation or indication of a region (e.g., area) of an image of a document. For example, a bounding box can be an example of a digital rectangle that encloses a portion of an image associated with a record, a field, or other region of an image. Although described herein as a square or rectangle, it is to be understood that a bounding box can include any shape and/or utilize any color scheme (e.g., bounding boxes associated with records can have a first color, bounding boxes associated with fields can have a second color, or bounding boxes associated with different types of fields can have corresponding colors, among other examples of color schemes). Further, although bounding boxes are shown herein as having a solid border with a transparent center for illustrative clarity, in some cases the bounding box can be a highlight box to indicate corresponding information (e.g., information in the document can be highlighted with a bounding box that includes a semi-transparent region of a color overlaid on top of the information).

Additionally, as used herein, the term “bounding box group” can refer to a group or collection of one or more bounding boxes as described herein. For example, a bounding box group can refer to a bounding box including or enclosing an aggregation of token-level areas or regions as described herein with reference to FIG. 2. To illustrate, in some cases the record management system 102 can generate an initial set of bounding boxes for an image where each bounding box corresponds to a token extracted from the image as described herein. The record management system 102 can aggregate one or more bounding boxes of the initial set into a single bounding box that can be referred to as a bounding box group (e.g., a bounding box group that includes each of the areas of the aggregated bounding boxes from the initial set of bounding boxes). In some cases, the bounding box group corresponds to a record or a field. For example, the record management system 102 can determine that a subset of the initial set of bounding boxes corresponds to tokens belonging to a record or field. The record management system 102 can aggregate the subset of initial bounding boxes into a single bounding box (e.g., a bounding box group) that includes each of the areas that include tokens that belong to that record or field.

As previously mentioned, the record management system 102 can generate tokens and bounding boxes for an image of a document. For example, the record management system 102 can use a record generation model to generate and/or aggregate bounding boxes into a bounding box group for display on an image within a graphical user interface of a client device. FIG. 6 illustrates an example architecture for the record management system 102 to generate bounding boxes and tokens in accordance with one or more embodiments.

As shown in FIG. 6 and as previously discussed herein, the record management system 102 can include one or more machine learning models. In the example of FIG. 6, the record management system 102 includes a transformer component 610, a decoder component 615, a bounding box head component 620-a, and a token head component 620-b. The components illustrated in FIG. 6 can be examples of or include components and/or machine learning models as described herein with reference to FIGS. 1-5. As an illustrative example, the transformer component 610 can be an example of the first machine learning model of FIG. 2, the decoder component 615 can be an example of the second machine learning model of FIG. 2, and the head components 620 can be examples of the third machine learning model and the fourth machine learning model, respectively, as described with reference to FIG. 2.

As shown in FIG. 6, the record management system 102 can receive an image 605 to analyze a document for records and fields. For example, the record management system 102 can utilize the transformer component 610, the decoder component 615, and the head components 620 to extract data from the image 605. The data can include (or indicate or represent) information in the image 605 that is associated with one or more records, one or more fields, or other information (e.g., information associated with a type of the document in the image, a geographical region associated with the data source depicted in the image 605, and the like).

In some examples, the record management system 102 extracts content from historical physical documents. For instance, the record management system 102 can utilize one or more machine learning models to receive an image 605 of a historical document as an input and outputs text (e.g., tokens 630 representing information extracted from the image 605). In some examples, the record management system 102 can perform a normalization process to convert the text to structured records. Additionally or alternatively, the record management system 102 can generate bounding boxes 635 indicating associated text in accordance with one or more embodiments described herein.

The transformer component 610 can process data of the image 605. For example, the transformer component 610 generated encoded image features from the input image 605. In some cases, the transformer component 610 includes a Swin transformer. The transformer component 610 can output the encoded image features to the decoder component 615.

The decoder component 615 can generate hidden states 625 utilizing the encoded image features. For example, the decoder component 615 can receive the encoded image features from the decoder component 615. The decoder component 615 can be an example of a machine learning model configured to process the encoded image features. For example, the decoder component 615 can generate tokens progressively as described herein with reference to FIG. 2. The decoder component 615 can generate hidden states 625 from the encoded image features received from the transformer component 610. In some cases, by utilizing the decoder component 615 and/or the transformer component 610, the record management system 102 can determine (e.g., generate) the hidden states 625 that correspond to the layout, structure, content, or other features of the input image 605.

The head components 620 can generate outputs utilizing the hidden states 625. The head components 620 can be examples of machine learning models that are configured on top of the transformer component 610 and the decoder component 615 (e.g., the head components 620 can generate objects from the output of the decoder component 615). The head component 620-a can be an example of a bounding box head. For example, the head component 620-a can generate bounding boxes 635 from the hidden states 625 (e.g., the head component 620-a can be a machine learning model configured to generate bounding boxes 635). To illustrate, the head component 620-a can generate a bounding box 635-a utilizing the hidden states 625-a, a bounding box 635-b from the hidden states 625-b, and so on.

Additionally, the head component 620-b can be an example of a token head. The For example, the head component 620-b can generate tokens 630 from the hidden states 625 (e.g., the head component 620-b can be a machine learning model configured to generate tokens 630). To illustrate, the head component 620-b can generate a token 630-a from the hidden states 625-a, a token 630-b from the hidden states 625-b, and so on. In some examples, the tokens can be generated in accordance with a markup language format as described herein. For example, the token head component 620-b can be configured to output text in the markup language format. As previously discussed, the markup language format can include content, tags associated with content, or both. For example, the tokens 630 can include record tags (e.g., a token that reads <record> and indicates that content tokens following the record tag token belong to a record) and field tags (e.g., a token that reads <field> and indicates that content tokens following the field tag token belong to that field). The tokens 630 can include content tokens. For example, the tokens 630 can include one or more tokens reading “John Doe” indicating content of the document reads “John Doe” (e.g., the tokens 630 reading John Doe can follow a record tag associated with a record for John Doe, a field tag associated with a name field, or both).

The head components 620 can generate a set of objects from the hidden states 625. For example, the head component 620-a can generate a set of bounding boxes 635 having a first quantity (e.g., a quantity of “L” bounding boxes) from the hidden states 625. The head component 620-b can generate a set of tokens 630 having the first quantity (e.g., a quantity of “L” tokens). In some examples, each token head object can have “C” channels (e.g., “C” can be a vocabulary size) and each bounding box head object can have another quantity of channels (e.g., 4 channels which represent various positional information as described herein).

In some examples, each bounding box 635 of the set corresponds to a respective token 630 and respective hidden states 625. For example, both head components 620 can use the same hidden states (e.g., hidden states 625-a) to generate an object (e.g., the bounding box 635-a and the token 630-a). Based on such a configuration, a bounding box 635 can correspond to an area of an associated token 630. To illustrate, the token 630-a can be located at a first position of the image 605. The bounding box 635-a can indicate the first position. For example, the bounding box 635-a can be output from the head component 620-a as a series of coordinates as described herein. As a merely illustrative example, the output of the head component 620-a for the bounding box 635-a can be an output with 4 channels that reads “[0.3, 0.40.1, 0.2],” where each of the four output numbers can represent positional information of the bounding box 635-a and/or the token 630-a (e.g., the numbers can be normalized to show a percentage across the image of a center of a box, a percentage down or up the image to the center of the box, a box length as a percentage of the total image length, and a box width as a percentage of the total image width). In some such examples, the bounding box 635-a can enclose or otherwise indicate the location of a corresponding token 630-a extracted from the image 605, the bounding box 635-b can enclose or otherwise indicate a location of a corresponding token 630-b, and so on.

In some examples, a desired quantity of bounding boxes can be different than the quantity of bounding boxes 635 included in the set output by the first head component 620-a. For example, the first head component 620-a can output “L” bounding boxes (e.g., “L” token-level areas as described herein with reference to FIG. 2), while the image 605 includes a relatively smaller quantity of “M” records, a relatively smaller quantity of “N” fields, or both (e.g., a ground truth of bounding boxes can include “M” bounding boxes for “M” records in the image 605 and “N” bounding boxes for “N” records in the image 605).

Accordingly, the record management system 102 can implement a matcher component as described herein (e.g., a fake matcher as described with reference to FIG. 4A). For example, the record management system 102 can utilize the matcher component to aggregate subsets of the set of bounding boxes 635 into bounding box groups that correspond to a field or record as described herein.

To illustrate, the matcher component can select a quantity of predictions (e.g., M+N predictions) and build one-to-one pairs for the selected predictions. In some examples, the matcher component can select initial bounding boxes 635 from the set of L bounding box proposals based on the corresponding token information from the head component 620-b. For example, the matcher component can select bounding boxes 635 from the set of bounding boxes that correspond to a token 630 that includes or indicates a record tag and/or a field tag. That is, by selecting bounding boxes 635 that have corresponding tokens 630 that are field or record tags, the matcher component can intelligently determine which bounding boxes to use as initial predictions where the quantity of initial predictions corresponds to the desired quantity of box proposals (e.g., M+N total initial bounding boxes for M records and N tags identified in the image 605). Indeed, as mentioned herein, the initial position of a selected bounding box 635-b will correspond to a location in the image 605 that includes the token 630-b that is a tag for an identified record or field. Thus, the efficiency of the record management system 102 is improved, for example, due to determining initial locations for bounding boxes of the image 605 that are located at or near the actual position of corresponding records and fields.

The record management system 102 can aggregate one or more of the selected initial bounding boxes 635 into bounding box groups. For example, the record management system 102 can select the bounding box 635-a based on the token 630-a being a record tag or a field tag. The record management system 102 can also select a bounding box 635-c as an initial proposal based on a corresponding token 630-c being a record or field tag. In some examples, the record management system 102 can aggregate one or more bounding boxes 635 that are between corresponding record or field tags. The record management system 102 can aggregate the initial bounding box 635-a that corresponds to a record tag token 630-a with one or more bounding boxes 635 that correspond to content tokens 630 following the record tag. Thus, the record management system 102 can generate a bounding box group that includes multiple areas associated with the multiple bounding boxes 635 and/or multiple tokens 630 that belong to a record or field. To illustrate, the bounding box 635-b can cover an area including the token 630-b that has a content token (e.g., “John”) and the record management system 102 can aggregate the bounding box 635-b with one or more other bounding boxes 635 (e.g., a box corresponding to a content token “Smith”) to form a single bounding box (e.g., a bounding box group) that includes the areas of each of the aggregated bounding boxes 635 (e.g., the bounding box group can cover an area that includes a record or field with the name “John Smith”).

In some examples, the record management system 102 can implement the matcher component in training operations (e.g., supervised training) of the record generation model. For example, the matcher component can build one-to-one pairs between predictions and ground truth (e.g., the matcher component can select box predictions that correspond to tokens 630 that have record or field indicators in the ground truth training data). The matcher component can place the selected box predictions in the same order that the corresponding tokens 630 appear in the ground truth. The matcher component can create pairs between the M+N predictions (e.g., the subset of bounding boxes 635) and the M+N ground truth boxes. For example, the matcher component can aggregate multiple bounding boxes 635 into a first bounding box group associated with a record, the matcher component can aggregate multiple bounding boxes 635 into a second bounding box group associated with a field and/or another record, etc., until the matcher component obtains M+N predictions of bounding box groups (e.g., to compare in training with M+N ground truth boxes). The record management system 102 can calculate one or more loss metrics associated with the paired predictions and ground truth boxes as described herein with reference to FIG. 2 (e.g., box giou loss, box L1 loss, class cross entropy loss, or a sum of one or more loss metrics). The record management system 102 can train the record generation model based on the loss metrics. For example, the record management system 102 can update parameters of one or more models based on the calculated loss metrics in training (e.g., the record management system 102 can sum the loss metrics prior to back propagation operations).

In some cases, the matching component can be referred to as a “fake matcher.” The matching component can generate or facilitate generation of bounding box groups for records and fields by matching predictions of bounding boxes (e.g., selecting a subset of bounding boxes 635 output by the head component 620-a) to corresponding tokens 630 (e.g., field or record tags), for example, instead of box similarity (e.g., a box similarity between a possible initial bounding box 635 and a ground truth bounding box proposal in training data), which can result in one or more of the improvements described herein with reference to FIGS. 1-5.

Additionally or alternatively, the record management system 102 can utilize the matcher component in inference operations. For example, the record management system 102 can utilize the matcher component when processing an image 605 that does not have corresponding “ground truth” data to compare with the result of the processing. That is, the record management system 102 can utilize the matcher component when processing an image 605 that is not an image 605 that the models/components of the record management system 102 have been exposed to in training.

For example, the record management system 102 can select a quantity of predictions from the output set of bounding boxes 635 from the head component 620-a utilizing the matcher component (e.g., the matcher component can build one-to-one pairs between boxes 635 and tokens 630 that correspond to record and/or field tags as described above). In inference, the matcher component can select bounding boxes 635 based on a prediction of the corresponding tokens 630 (e.g., rather than a ground truth of the corresponding token 630). The matcher component can create pairs between the selected bounding boxes 635 and the predicted tokens 630 in sequence. For example, the matcher component can predict “N” fields in “M” records where each field and record has a paired bounding box. In some examples, the paired bounding box 635 can be a selected bounding box 635 (e.g., a bounding box 635-a that corresponds to a record tag token 630-a) and/or bounding boxes 635 that have been aggregated into a bounding box group with the selected bounding box as described above (e.g., token-level areas corresponding to the record tag token 630-a and/or one or more content tokens 630).

In some examples, the record management system 102 can generate a depiction of a bounding box group and provide an image with the depiction of the group. For example, the record management system 102 can aggregate bounding boxes 635 associated with tokens 630 of a record into a single bounding box and display the image 605 with the single bounding box enclosing or highlighting the associated record via a graphical user interface of a client device. In some embodiments, the single bounding box can enclose, highlight, indicate, or otherwise show areas of the image 605 that include information of a record or field (e.g., text indicated by a subset of tokens 630 that correspond to the aggregated bounding boxes 635).

As an illustrative example of processing an image 605, the record management system 102 can receive, select, or otherwise provide the image 605 to the transformer component 610. For instance, the image 605 can be an example of a baptism record having multiple rows (e.g., records associated with different individuals) and multiple fields in each row (e.g., a name field, a baptism date field, etc.). The record management system 102 can utilize the architectures and operations described herein to generate a bounding box group for one or more records (e.g., a box around each row or a row associated with a particular individual), a bounding box for one or more fields (e.g., a bounding box around each cell in a row of one or more records), or both.

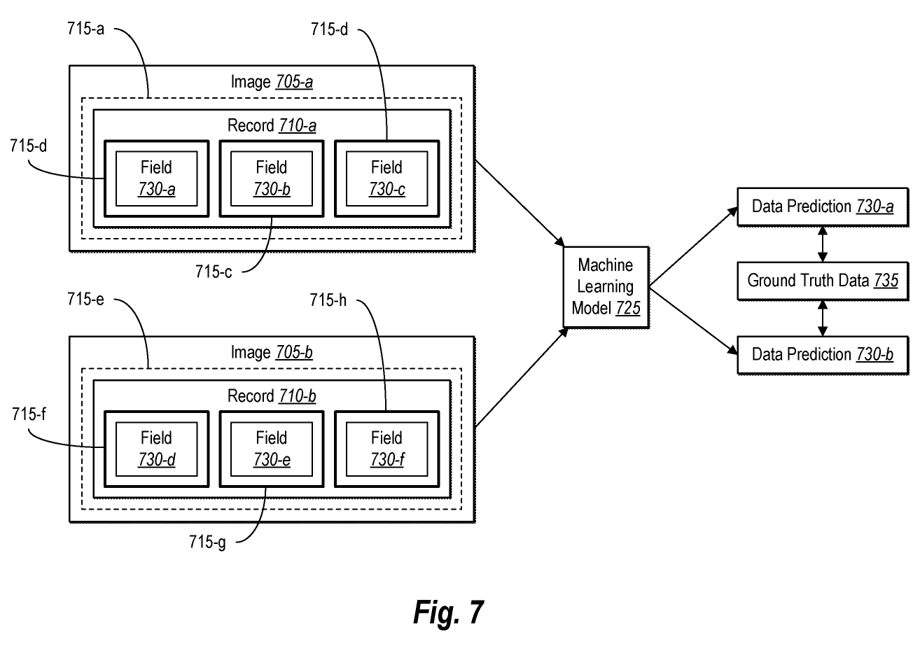

As previously mentioned, in some embodiments the record management system 102 can train one or more models. For example, the record management system 102 can utilize supervised machine learning training, weakly supervised machine learning training, or both to train the various models described herein (e.g., the record generation model and/or its components). FIG. 7 illustrates two examples of training architectures for training a record generation model in accordance with one or more embodiments.

As shown in FIG. 7, a machine learning model 725 (e.g., a record generation model as described with reference to FIG. 6) can be trained in a first training architecture illustrated via processing image 705-a to obtain data prediction 730-a. In some examples, the first training architecture can be an example of a supervised machine learning training architecture.

For example, the machine learning model 725 can receive the image 705-a as an input. The machine learning model 725 can process the image 705-a in accordance with one or more embodiments described herein. For example, the machine learning model 725 can extract or determine a set of tokens (e.g., tokens indicating content of the image, token tags, and field tags) and a set of bounding boxes (e.g., bounding boxes and/or bounding box groups corresponding to the record 710-a, the fields 720, or both).

The image 705-a can be a training image in a training dataset. For example, the image 705-a can correspond to ground truth data 735 (e.g., the ground truth data 735 can include a ground truth set of tokens and a ground truth set of bounding boxes for the fields 720 and records 710 in the image 705-a). The machine learning model 725 can process the image 705-a and generate a data prediction 730-a. For instance, the machine learning model 725 can generate a set of predicted bounding box groups (e.g., a bounding box group for the record 710-a, a bounding box group for a field 720-a, a bounding box group for a field 720-b, and a bounding box group for the field 720-c). As an illustrative example, the image 705-a depicts a bounding box 715-a showing a location of the record 710-a, a bounding box 715-b showing a location of the field 720-a, a bounding box 715-c showing a location of the field 720-b, and a bounding box 715-c showing a location of the field 720-c.

The record management system 102 can train the machine learning model 725 based on the data prediction 730-a and the ground truth data 735. For example, the record management system 102 can determine loss metrics between the ground truth data 735 and the data prediction 730-a as described herein with reference to FIGS. 1-6. The record management system 102 can adjust parameters of the machine learning model 725 to minimize losses between the data prediction 730-a and the ground truth data 735. In some cases, the record management system 102 can perform such training processes iteratively to improve the performance of the machine learning model 725. As an example, the machine learning model 725 can generate the data prediction 730-a that includes a set of tokens reading “Burial; John M. Smith; York <record> sg-Jan; ss-Doe; vd-22/Jul/1930; ag-80” and predict bounding boxes for the record 710-a and/or the fields 720-a, 720-b, and 720-c. The record management system 102 can compare the data prediction 730-a to a set of ground truth tokens reading “Burial; John M. Smith; York <record> sg-Jane; ss-Doe; vd-22/Jul/1930; ag-80” and/or a set of ground truth training bounding boxes (e.g., manually annotated bounding boxes and/or training bounding boxes generated from a weakly supervised machine learning model training as described herein). The record management system 102 can calculate one or more loss metrics and train the machine learning model 725 based on the loss metrics by updating one or more parameters of the machine learning model.

Additionally or alternatively, the machine learning model 725 can be trained in a second training architecture illustrated via processing image 705-b to obtain data prediction 730-b. In some examples, the second training architecture can be an example of a weakly supervised machine learning training architecture. For example, as discussed above, the weakly supervised machine learning training architecture can enable the record management system 102 to train the machine learning model 725 without manually annotated ground truth bounding boxes in the ground truth data 735.

As an illustrative example, the image 705-b can include a record 710-b and fields 720-d, 720-e, and 720-f. The record management system 102 can generate region proposals for the image 705-b. For example, the record management system 102 can use a table transformer (e.g., one or more machine learning models to perform table detection, table structure recognition, table functional analysis, and the like) to generate the region proposals for the image 705-b. However, the region proposals may or may not correspond to field or record information in the image 705-b. That is, the record management system 102 can generate the region proposals without utilizing text or token information from the image 705-b. While generating region proposals in this way can utilize less processing power, reduced latency, or less cost (e.g., compared to manual annotation of bounding boxes), the region proposals can be relatively inaccurate as a result.

Accordingly, the record management system 102 can utilize masking operations as described herein to refine the region proposals and train the machine learning model 725 to more accurately predict bounding boxes for the records 710 and/or fields 720 of images 705. In this manner, the record management system 102 can realize reduced costs, improved computational efficiency, and improved scalability and flexibility of training. In some cases, the second training architecture utilizes a token ground truth (e.g., ground truth data 735 can include a set of tokens of one or more records in a document of an image 705-b) and the region proposals (e.g., each region proposal can be an initial bounding box which may or may not indicate the location of a field). A region proposal can be referred to as a training box or a training bounding box.

The record management system 102 can iteratively mask one or more records 710 and fields 720 in an image 705 to determine an accuracy of a region proposal and update parameters of the machine learning model 725 to more accurately predict bounding boxes. As an illustrative example, the record management system 102 can randomly select a training boundary box (e.g., a region proposal from a table transformer). The record management system 102 can mask the selected box that, in this example, includes at least a portion of the field 720-e (e.g., the record management system 102 can hide or otherwise obscure the area within a region proposal that includes the field 720-e). The machine learning model 725 can process the image 705-b with the masked region proposal to generate the data prediction 730-b. The data prediction 730-b can include a set of tokens (e.g., a set of tokens that reads “Burial; John M. Smith; York <record> sg-a; ss-Doe; vd-22/Jul/1930; ag-80”).

The record management system 102 can determine an accuracy of the masked region proposal based on the data prediction 730-b. For example, the record management system 102 can compare the output set of tokens to a ground truth set of tokens in the ground truth data 735 (e.g., a set of tokens reading “Burial; John M. Smith; York <record> sg-Jane; ss-Doe; vd-22/Jul/1930; ag-80”). The record management system 102 can determine that the field 720-e corresponds to the masked training box based on a relatively high loss metric between the generated set of tokens and the ground truth set of tokens (e.g., the prediction of the field “sg” is “a” in the data prediction 730-b and the ground truth field “sg” is “Jane” in the ground truth data 735). The relatively high loss metric indicates that the masked training box included the information of the field 720-e.

By determining which information is included in which initial region proposals, the record management system 102 can generate ground truth training boxes that correspond to fields 720 and records 710. For example, the record management system 102 can utilize a matching component (e.g., a weak fake matcher) to map a box prediction (e.g., a prediction of a bounding box from the machine learning model 725) with a box proposal (e.g., the masked region proposal). In some cases, the training process of the machine learning model 725 can utilize aspects of the first training architecture after establishing a mapping between the box prediction and the box proposal. For example, the record management system 102 can train the machine learning model 725 in the first training architecture (e.g., a supervised training) utilizing a ground truth training box (e.g., the mapped box prediction) that is generated from the second training architecture operations. Additionally or alternatively, the record management system 102 can utilize the masking operations to enhance structural understanding of an image 705 for inference operations as described herein with reference to FIG. 6. For example, the record management system 102 can utilize masking operations to evaluate an accuracy of a result of an inference operation.

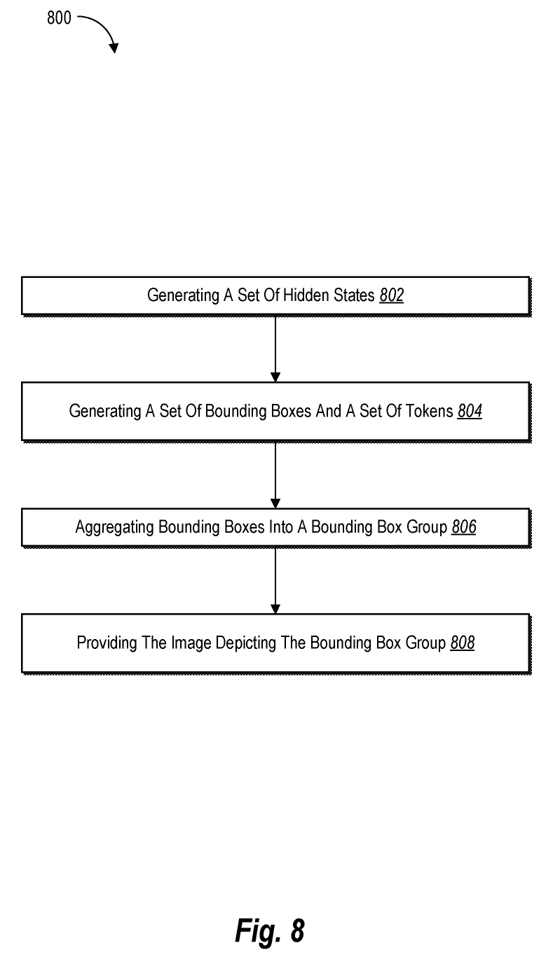

FIGS. 1-7, the corresponding text, and the examples provide a number of different systems and methods for generating bounding boxes in accordance with one or more embodiments. In addition to the foregoing, implementations can also be described in terms of flowcharts comprising acts and/or steps in a method for accomplishing a particular result. For example, FIG. 8 illustrates an example series of acts for providing an image depicting a bounding box group in accordance with one or more embodiments.

While FIG. 8 illustrates acts according to certain implementations, alternative implementations may omit, add to, reorder, and/or modify any of the acts shown in FIG. 8. The acts of FIG. 8 can be performed as part of a computer-implemented method. Alternatively, a non-transitory computer-readable medium can comprise instructions that, when executed by one or more processors, cause a computing device to perform the acts of FIG. 8. In still further implementations, a system can perform the acts of FIG. 8.

As illustrated, the series of acts 800 can include an act 802 of generating a set of hidden states. Specifically, the act 802 can include generating, utilizing a transformer component and a decoder component of a record generation model, a set of hidden states for an image of a document from a client device. Additionally, the series of acts 800 can include an act 804 of generating a set of bounding boxes and a set of tokens. Specifically, the act 804 can include generating, utilizing a first head component and a second head component of the record generation model, a set of bounding boxes and a set of tokens from the set of hidden states, each bounding box of the set of bounding boxes corresponding to a respective token of the set of tokens. Further, the series of acts 800 can include an act 806 of aggregating bounding boxes into a bounding box group. Specifically, the act 806 can include aggregating, utilizing a matcher component of the record generation model, a plurality of bounding boxes of the set of bounding boxes into a bounding box group that corresponds to a subset of tokens of the set of tokens. In addition, the series of acts 800 can include an act 808 of providing the image depicting the bounding box group. Specifically, the act 808 can providing, for display within a graphical user interface of the client device, the image depicting the bounding box group that corresponds to the subset of tokens.

As shown in FIG. 8, the series of acts 800 includes an act 802 of generating a set of hidden states, an act 804 of generating a set of bounding boxes and a set of tokens, an act 806 of aggregating bounding boxes into a bounding box group, and an act 808 of providing the image depicting the bounding box group. For example, the series of acts 800 can include acts to perform any of the operations described in the following clauses:

Clause 1. A computer-implemented method comprising: generating, utilizing a transformer component and a decoder component of a record generation model, a set of hidden states for an image of a document from a client device; generating, utilizing a first head component and a second head component of the record generation model, a set of bounding boxes and a set of tokens from the set of hidden states, each bounding box of the set of bounding boxes corresponding to a respective token of the set of tokens; aggregating, utilizing a matcher component of the record generation model, a plurality of bounding boxes of the set of bounding boxes into a bounding box group that corresponds to a subset of tokens of the set of tokens; and providing, for display within a graphical user interface of the client device, the image depicting the bounding box group that corresponds to the subset of tokens.

Clause 2. The computer-implemented method of clause 1, further comprising: pairing, utilizing the matcher component, each bounding box of the bounding box group to a respective token of the subset of tokens based on the respective token corresponding to a field tag or a record tag.

Clause 3. The computer-implemented method of any of clauses 1-2, wherein generating the set of bounding boxes and the set of tokens further comprises: generating, from a subset of the set of hidden states, one or more bounding boxes of the set of bounding boxes; and generating, from the subset of the set of hidden states, one or more tokens that correspond to the one or more bounding boxes.

Clause 4. The computer-implemented method of any of clauses 1-3, wherein generating the set of bounding boxes and the set of tokens further comprises: generating the set of tokens in accordance with a markup language format comprising content tokens indicating text extracted from the image of the document, record tags indicating that one or more content tokens associated with a record tag correspond to a record in the image of the document, and field tags indicating that one or more content tokens associated with a field tag correspond to a field in the image of the document.

Clause 5. The computer-implemented method of any of clauses 1-4, further comprising: generating a depiction of the bounding box group as a positional rectangle enclosing a portion of the image comprising information associated with a field or record of the image, wherein the subset of tokens of the set of tokens corresponds to the information associated with the field or record of the image.

Clause 6. The computer-implemented method of any of clauses 1-5, further comprising: generating the set of bounding boxes, the set of tokens, the set of hidden states, or a combination thereof utilizing the record generation model trained by: generating a set of training tokens and a set of training boxes for a training image; masking one or more training boxes in the set of training boxes; and updating one or more parameters of the record generation model based on a loss associated with masking the one or more training boxes.

Clause 7. The computer-implemented method of any of clauses 1-6, wherein the record generation model is further trained by: generating a prediction of data based on masking the one or more training boxes; determining the loss associated with masking the one or more training boxes by comparing the prediction of data with training data associated with the training image; and determining that a masked training box of the one or more training boxes corresponds to a subset of training tokens based on the loss satisfying a threshold loss.

Clause 8. A system comprising: at least one processor; and at least one non-transitory computer-readable storage medium storing instructions that, when executed by the at least one processor, cause the system to: generate, utilizing a transformer component and a decoder component of a record generation model, a set of hidden states for an image of a document from a client device; generating, utilizing a first head component and a second head component of the record generation model, a set of bounding boxes and a set of tokens from the set of hidden states, each bounding box of the set of bounding boxes corresponding to a respective token of the set of tokens; aggregating, utilizing a matcher component of the record generation model, a plurality of bounding boxes of the set of bounding boxes into a bounding box group that corresponds to a subset of tokens of the set of tokens; and providing, for display within a graphical user interface of the client device, the image depicting the bounding box group that corresponds to the subset of tokens.

Clause 9. The system of clause 8, further comprising instructions that, when executed by the at least one processor, cause the system to: pair, utilizing the matcher component, each bounding box of the bounding box group to a respective token of the subset of tokens based on the respective token corresponding to a field tag or a record tag.

Clause 10. The system of any of clauses 8-9, further comprising instructions that, when executed by the at least one processor, cause the system to generate the set of bounding boxes and the set of tokens by: generating, from a subset of the set of hidden states, one or more bounding boxes of the set of bounding boxes; and generating, from the subset of the set of hidden states, one or more tokens that correspond to the one or more bounding boxes.

Clause 11. The system of any of clauses 8-10, further comprising instructions that, when executed by the at least one processor, cause the system to generate the set of bounding boxes and the set of tokens by: generating the set of tokens in accordance with a markup language format comprising content tokens indicating text extracted from the image of the document, record tags indicating that one or more content tokens associated with a record tag correspond to a record in the image of the document, and field tags indicating that one or more content tokens associated with a field tag correspond to a field in the image of the document.

Clause 12. The system of any of clauses 8-11, further comprising instructions that, when executed by the at least one processor, cause the system to: generating a depiction of the bounding box group as a positional rectangle enclosing a portion of the image comprising information associated with a field or record of the image, wherein the subset of tokens of the set of tokens corresponds to the information associated with the field or record of the image.

Clause 13. The system of any of clauses 8-12, further comprising instructions that, when executed by the at least one processor, cause the system to: generate the set of bounding boxes, the set of tokens, the set of hidden states, or a combination thereof utilizing the record generation model trained by: generating a set of training tokens and a set of training boxes for a training image; masking one or more training boxes in the set of training boxes; and updating one or more parameters of the record generation model based on a loss associated with masking the one or more training boxes.

Clause 14. The system of any of clauses 8-13, wherein the record generation model is further trained by: generating a prediction of data based on masking the one or more training boxes; determining the loss associated with masking the one or more training boxes by comparing the prediction of data with training data associated with the training image; and determining that a masked training box of the one or more training boxes corresponds to a subset of training tokens based on the loss satisfying a threshold loss.

Clause 15. A non-transitory computer-readable medium storing instructions that, when executed by at least one processor, cause a computing device to: generate, utilizing a transformer component and a decoder component of a record generation model, a set of hidden states for an image of a document from a client device; generate, utilizing a first head component and a second head component of the record generation model, a set of bounding boxes and a set of tokens from the set of hidden states, each bounding box of the set of bounding boxes corresponding to a respective token of the set of tokens; aggregate, utilizing a matcher component of the record generation model, a plurality of bounding boxes of the set of bounding boxes into a bounding box group that corresponds to a subset of tokens of the set of tokens; and provide, for display within a graphical user interface of the client device, the image depicting the bounding box group that corresponds to the subset of tokens.

Clause 16. The non-transitory computer-readable medium of clause 15, further comprising instructions that, when executed by the at least one processor, cause the computing device to: pair, utilizing the matcher component, each bounding box of the bounding box group to a respective token of the subset of tokens based on the respective token corresponding to a field tag or a record tag.

Clause 17. The non-transitory computer-readable medium of any of clauses 15-16, further comprising instructions that, when executed by the at least one processor, cause the computing device to: generate, from a subset of the set of hidden states, one or more bounding boxes of the set of bounding boxes; and generate, from the subset of the set of hidden states, one or more tokens that correspond to the one or more bounding boxes.

Clause 18. The non-transitory computer-readable medium of any of clauses 15-17, further comprising instructions that, when executed by the at least one processor, cause the computing device to: generate the set of tokens in accordance with a markup language format comprising content tokens indicating text extracted from the image of the document, record tags indicating that one or more content tokens associated with a record tag correspond to a record in the image of the document, and field tags indicating that one or more content tokens associated with a field tag correspond to a field in the image of the document.

Clause 19. The non-transitory computer-readable medium of any of clauses 15-18, further comprising instructions that, when executed by the at least one processor, cause the computing device to: generate a depiction of the bounding box group as a positional rectangle enclosing a portion of the image comprising information associated with a field or record of the image, wherein the subset of tokens of the set of tokens corresponds to the information associated with the field or record of the image.

Clause 20. The non-transitory computer-readable medium of any of clauses 15-19, further comprising instructions that, when executed by the at least one processor, cause the computing device to: generate the set of bounding boxes, the set of tokens, the set of hidden states, or a combination thereof utilizing the record generation model trained by: generating a set of training tokens and a set of training boxes for a training image; masking one or more training boxes in the set of training boxes; and updating one or more parameters of the record generation model based on a loss associated with masking the one or more training boxes.

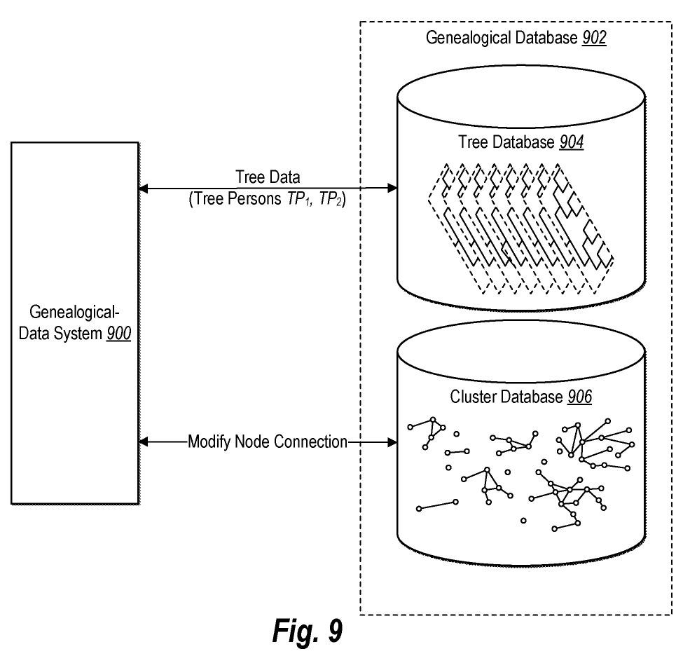

FIG. 9 illustrates a genealogical-data system 900 interfacing with a genealogical database 902 in accordance with one or more embodiments. For certain genealogical databases, the genealogical-data system 900 identifies groups of user nodes or records in the format of a genealogical tree or records connected by biological and other family relationships as “tree data.” The genealogical-data system 900 can thus search and process tree data stored in a genealogical database 902 (which includes a tree database 904 and a cluster database 906) to execute tasks and perform functions as described herein.

In one or more embodiments, the genealogical-data system 900 can resolve duplicate entities corresponding to respective genealogical records. Indeed, the genealogical-data system 900 can determine that two entities in a cluster database are the same individual, despite differences in various data, such as name spelling, discrepancies in certain dates, and/or other variances in data. The genealogical-data system 900 can analyze clusters of genealogical records stored for each individual within the cluster database 906 to determine that the clusters are within a threshold similarity of one another and that, therefore, the clusters should be combined or otherwise resolved to represent a single individual. In some cases, the genealogical-data system 900 can compare clusters by extracting vectors from the genealogical records in the clusters, averaging the vectors to generate cluster vectors (or otherwise determining weighted or unweighted cluster centers) representative of respective clusters, and determining distances (e.g., Euclidean or cosine distances) between the cluster vectors. The genealogical-data system 900 can further propagate such entity resolution to the tree database 904 to update nodes and edges within a universal genealogical tree, resolving two previously disparate nodes into a single node as indicated by the newly resolved (or combined clusters in the cluster database 906.

For the genealogical database 902, the genealogical-data system 900 may receive genealogical data (e.g., data records and/or genealogical data objects) for building tree data from a source selected from a ground-truth genealogical tree generated from genealogical records and trees of user accounts within the genealogical-data system 900, from the Ancestry World Tree system, a Social Security Death Index database, the World Family Tree system, a birth certificate database, a death certificate database, a marriage certificate database, an adoption database, a draft registration database, a veterans database, a military database, a property records database, a census database, a voter registration database, a phone database, an address database, a newspaper database, an immigration database, a family history records database, a local history records database, a business registration database, and/or a motor vehicle database. Additionally, genealogical data can be user-generated. Genealogical data may also include data from a cluster database 906 derived from records and user data.

Some embodiments of the record management system 102 relate to modifying a cluster database 906 based on a user query and/or other interaction with the record management system 102. In some instances, the genealogical-data system 900 (or the record management system 102) determines and/or modifies a node connection for an individual represented by or resolved to a cluster within the cluster database 906. Indeed, the record management system 102 can analyze, add, remove, and/or modify genealogical content items organized into clusters within the cluster database 906 based on relatedness corresponding to a common individual. The record management system 102 can also access, modify, and analyze genealogical trees within the tree database 904 by, for example, adding nodes, removing nodes, and/or modifying nodes based on genealogical content items (and their relationships to individuals) stored within the cluster database 906.

As seen in FIG. 9, the genealogical-data system 900 includes a genealogical database 902, which may include a tree database 904 and a cluster database 906. The tree database 904 may be configured to facilitate the generation, storage, and collation of family trees for a plurality of users, with trees comprising nodes and edges therebetween. Data and records, such as images, may be associated with individual nodes of the trees in the tree database 904. Tree person data, including data such as names, relationships, dates, events, and other metadata may be provided by the tree database 904 to the genealogical-data system 900. The cluster database 906 may include one or more clusters comprising resolved entities, where tree persons (nodes) in different trees in the tree database 904 are associated together in a cluster after determination that the tree persons correspond to a same person.

As a user expands their family tree, the tree database 904 may be modified as the user’s family tree is expanded, and the cluster database 906 may be modified to include the new node in the pertinent cluster. For example, the record management system 102 can modify the cluster database 906 to include a new node responsive to one or more operations described herein. Indeed, the record management system 102 can generate the new node to correspond to an entity that the record management system 102 extracts from an image. Further, the record management system 102 can generate bounding boxes, training data, or other data as described herein for future operations within the genealogical-data system 900 and/or the record management system 102.

### Computing Machine Architecture

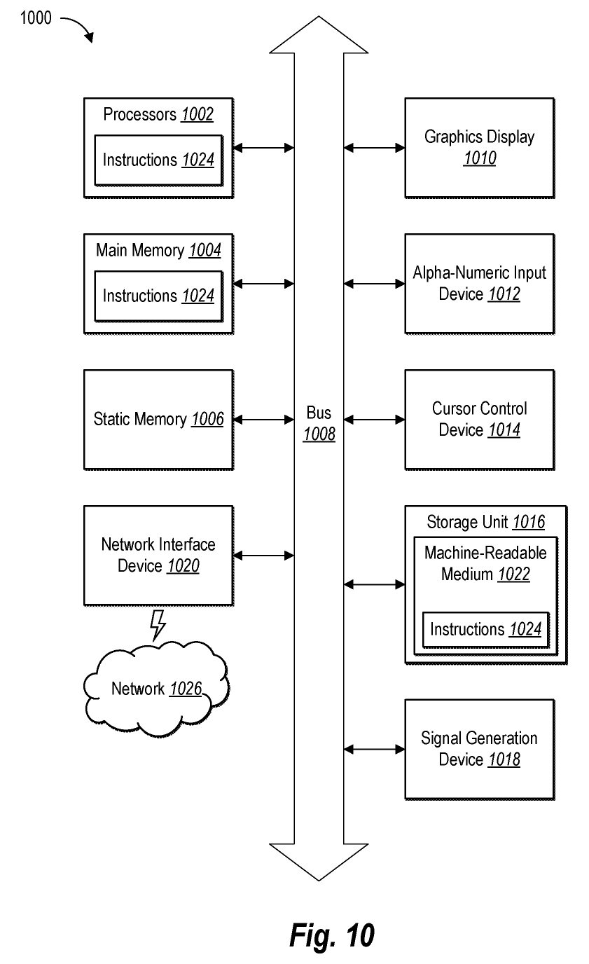

FIG. 10 is a block diagram illustrating components of an example computing machine that is capable of reading instructions from a computer-readable medium and executing them in a processor (or controller). A computer described herein may include a single computing machine shown in FIG. 10, a virtual machine, a distributed computing system that includes multiple nodes of computing machines shown in FIG. 10, or any other suitable arrangement of computing devices.

By way of example, FIG. 10 shows a diagrammatic representation of a computing machine in the example form of a computer system 1000 within which instructions 1024 (e.g., software, source code, program code, expanded code, object code, assembly code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 10 may correspond to any software, hardware, or combined components shown in FIGS. 1 and 2, including but not limited to, the client device 110, the computing server 130, the record management system 102, and various engines, interfaces, terminals, and machines shown in FIG. 2. While FIG. 10 shows various hardware and software elements, each of the components described in FIGS. 1 and 2 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 1024 that specify actions to be taken by that machine. Further, while only a single machine is illustrated, the terms “machine” and “computer” may also be taken to include any collection of machines that individually or jointly execute instructions 1024 to perform any one or more of the methodologies discussed herein.

The example computer system 1000 includes one or more processors 1002 such as a CPU (central processing unit), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 1000 may also include a memory 1004 that stores computer code including instructions 1024 that may cause the processors 1002 to perform certain actions when the instructions are executed, directly or indirectly by the processors 1002. Instructions can be any directions, commands, or orders that may be stored in different forms, such as equipment-readable instructions, programming instructions including source code, and other communication signals and orders. Instructions may be used in a general sense and are not limited to machine-readable codes. One or more steps in various processes described may be performed by passing through instructions to one or more multiply-accumulate (MAC) units of the processors.

One or more methods described herein improve the operation speed of the processor 1002 and reduce the space required for the memory 1004. For example, the database processing techniques and machine learning methods described herein reduce the complexity of the computation of the processors 1002 by applying one or more novel techniques that simplify the steps in training, reaching convergence, and generating results of the processors 1002. The algorithms described herein also reduce the size of the models and datasets to reduce the storage space requirement for memory 1004.

The performance of certain operations may be distributed among more than one processor, not only residing within a single machine, but deployed across a number of machines. In some example embodiments, the one or more processors or processor-implemented modules may be located in a single geographic location (e.g., within a home environment, an office environment, or a server farm). In other example embodiments, one or more processors or processor-implemented modules may be distributed across a number of geographic locations. Even though the specification or the claims may refer to some processes to be performed by a processor, this may be construed to include a joint operation of multiple distributed processors. In some embodiments, a computer-readable medium comprises one or more computer-readable media that, individually, together, or distributedly, comprise instructions that, when executed by one or more processors, cause the one or more processors to perform, individually, together, or distributedly, the steps of the instructions stored on the one or more computer-readable media. Similarly, a processor comprises one or more processors or processing units that, individually, together, or distributedly, perform the steps of instructions stored on a computer-readable medium. In various embodiments, the discussion of one or more processors that carry out a process with multiple steps does not require any one of the processors to carry out all of the steps. For example, a processor A can carry out step A, a processor B can carry out step B using, for example, the result from the processor A, and a processor C can carry out step C, etc. The processors may work cooperatively in this type of situation such as in multiple processors of a system in a chip, in Cloud computing, or in distributed computing.

The computer system 1000 may include a main memory 1004, and a static memory 1006, which are configured to communicate with each other via a bus 1008. The computer system 1000 may further include a graphics display unit 1010 (e.g., a plasma display panel (PDP), a liquid crystal display (LCD), a projector, or a cathode ray tube (CRT)). The graphics display unit 1010, controlled by the processor 1002, displays a graphical user interface (GUI) to display one or more results and data generated by the processes described herein. The computer system 1000 may also include an alphanumeric input device 1012 (e.g., a keyboard), a cursor control device 1014 (e.g., a mouse, a trackball, a joystick, a motion sensor, or other pointing instruments), a storage unit 1016 (a hard drive, a solid-state drive, a hybrid drive, a memory disk, etc.), a signal generation device 1018 (e.g., a speaker), and a network interface device 1020, which also are configured to communicate via the bus 1008.

The storage unit 1016 includes a computer-readable medium 1022 on which is stored instructions 1024 embodying any one or more of the methodologies or functions described herein. The instructions 1024 may also reside, completely or at least partially, within the main memory 1004 or within the processor 1002 (e.g., within a processor’s cache memory) during execution thereof by the computer system 1000, the main memory 1004 and the processor 1002 also constituting computer-readable media. The instructions 1024 may be transmitted or received over a network 1026 via the network interface device 1020.

While computer-readable medium 1022 is shown in an example embodiment to be a single medium, the term “computer-readable medium” should be taken to include a single medium or multiple media (e.g., a centralized or distributed database, or associated caches and servers) able to store instructions (e.g., instructions 1024). The computer-readable medium may include any medium that is capable of storing instructions (e.g., instructions 1024) for execution by the processors (e.g., processors 1002) and that cause the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g. method, can be claimed in another claim category, e.g. computer program product, system, or storage medium, as well. The dependencies or references in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcodes, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In some embodiments, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed in the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

The following applications are incorporated by reference in their entirety for all purposes: (1) U.S. Patent No. 10,679,729, entitled “Haplotype Phasing Models,” granted on June 9, 2020, (2) U.S. Patent No. 10,223,498, entitled “Discovering Population Structure from Patterns of Identity-By-Descent,” granted on March 5, 2019, (3) U.S. Patent No. 10,720,229, entitled “Reducing Error in Predicted Genetic Relationships,” granted on July 21, 2020, (4) U.S. Patent No. 10,558,930, entitled “Local Genetic Ethnicity Determination System,” granted on February 11, 2020, (5) U.S. Patent No. 10,114,922, entitled “Identifying Ancestral Relationships Using a Continuous Stream of Input,” granted on October 30, 2018, (6) U.S. Patent No. 11,429,615, entitled “Linking Individual Datasets to a Database,” granted on August 30, 2022, (7) U.S. Patent No. 10,692,587, entitled “Global Ancestry Determination System,” granted on June 23, 2020, and (8) U.S. Patent Application Publication No. US 2021/0034647, entitled “Clustering of Matched Segments to Determine Linkage of Dataset in a Database,” published on February 4, 2021.

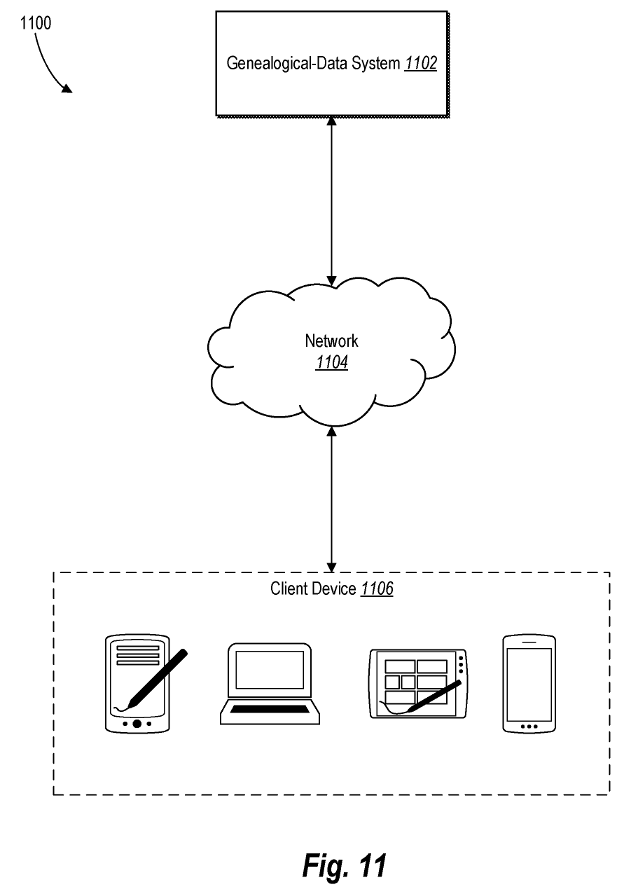

FIG. 11 is a schematic diagram illustrating environment 1100 within which one or more implementations of the record management system 102 can be implemented. For example, the record management system 102 may be part of a genealogical-data system 1102. The genealogical-data system 1102 may generate, store, manage, receive, and send digital content (such as genealogical records). For example, genealogical-data system 1102 may send and receive digital content to and from client devices 1106 by way of network 1104. In particular, genealogical-data system 1102 can store and manage genealogical databases for various user accounts, historical records, and genealogical trees. In some embodiments, the genealogical-data system 1102 can manage the distribution and sharing of digital content between computing devices associated with user accounts. For instance, the genealogical-data system 1102 can facilitate a user account sharing a genealogical record with another user account of genealogical-data system 1102.

In particular, the genealogical-data system 1102 can manage synchronizing digital content across multiple client devices 1106 associated with one or more user accounts. For example, a user may edit a digitized historical document or a node within a genealogical tree using client device 1106. The genealogical-data system 1102 can cause client device 1106 to send the edited genealogical content to the genealogical-data system 1102, whereupon the genealogical-data system 1102 synchronizes the genealogical content on one or more additional computing devices.

As shown, the client device 1106 may be a desktop computer, a laptop computer, a tablet computer, an augmented reality device, a virtual reality device, a personal digital assistant (PDA), an in- or out-of-car navigation system, a handheld device, a smart phone or other cellular or mobile phone, or a mobile gaming device, other mobile device, or other suitable computing devices. The client device 1106 may execute one or more client applications, such as a web browser (e.g., Microsoft Windows Internet Explorer, Mozilla Firefox, Apple Safari, Google Chrome, Opera, etc.) or a native or special-purpose client application (e.g., Ancestry: Family History & DNA for iPhone or iPad, Ancestry: Family History & DNA for Android, etc.), to access and view content over the network 1104.

The network 1104 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1106 may access genealogical-data system 1102.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope

What is claimed is:

1. A computer-implemented method comprising:
generating, utilizing a transformer component and a decoder component of a record generation model, a set of hidden states for an image of a document from a client device;
generating, utilizing a first head component and a second head component of the record generation model, a set of bounding boxes and a set of tokens from the set of hidden states, each bounding box of the set of bounding boxes corresponding to a respective token of the set of tokens;
aggregating, utilizing a matcher component of the record generation model, a plurality of bounding boxes of the set of bounding boxes into a bounding box group that corresponds to a subset of tokens of the set of tokens; and
providing, for display within a graphical user interface of the client device, the image depicting the bounding box group that corresponds to the subset of tokens.

2. The computer-implemented method of claim 1, further comprising:
pairing, utilizing the matcher component, each bounding box of the bounding box group to a respective token of the subset of tokens based on the respective token corresponding to a field tag or a record tag.

3. The computer-implemented method of claim 1, wherein generating the set of bounding boxes and the set of tokens further comprises:
generating, from a subset of the set of hidden states, one or more bounding boxes of the set of bounding boxes; and
generating, from the subset of the set of hidden states, one or more tokens that correspond to the one or more bounding boxes.

4. The computer-implemented method of claim 1, wherein generating the set of bounding boxes and the set of tokens further comprises:
generating the set of tokens in accordance with a markup language format comprising content tokens indicating text extracted from the image of the document, record tags indicating that one or more content tokens associated with a record tag correspond to a record in the image of the document, and field tags indicating that one or more content tokens associated with a field tag correspond to a field in the image of the document.

5. The computer-implemented method of claim 1, further comprising:
generating a depiction of the bounding box group as a positional rectangle enclosing a portion of the image comprising information associated with a field or record of the image, wherein the subset of tokens of the set of tokens corresponds to the information associated with the field or record of the image.

6. The computer-implemented method of claim 1, further comprising:
generating the set of bounding boxes, the set of tokens, the set of hidden states, or a combination thereof utilizing the record generation model trained by:
generating a set of training tokens and a set of training boxes for a training image;
masking one or more training boxes in the set of training boxes; and
updating one or more parameters of the record generation model based on a loss associated with masking the one or more training boxes.

7. The computer-implemented method of claim 6, wherein the record generation model is further trained by:
generating a prediction of data based on masking the one or more training boxes;
determining the loss associated with masking the one or more training boxes by comparing the prediction of data with training data associated with the training image; and
determining that a masked training box of the one or more training boxes corresponds to a subset of training tokens based on the loss satisfying a threshold loss.

8. A system comprising:
at least one processor; and
at least one non-transitory computer-readable storage medium storing instructions that, when executed by the at least one processor, cause the system to:
generate, utilizing a transformer component and a decoder component of a record generation model, a set of hidden states for an image of a document from a client device;
generating, utilizing a first head component and a second head component of the record generation model, a set of bounding boxes and a set of tokens from the set of hidden states, each bounding box of the set of bounding boxes corresponding to a respective token of the set of tokens;
aggregating, utilizing a matcher component of the record generation model, a plurality of bounding boxes of the set of bounding boxes into a bounding box group that corresponds to a subset of tokens of the set of tokens; and
providing, for display within a graphical user interface of the client device, the image depicting the bounding box group that corresponds to the subset of tokens.

9. The system of claim 8, further comprising instructions that, when executed by the at least one processor, cause the system to:
pair, utilizing the matcher component, each bounding box of the bounding box group to a respective token of the subset of tokens based on the respective token corresponding to a field tag or a record tag.

10. The system of claim 8, further comprising instructions that, when executed by the at least one processor, cause the system to generate the set of bounding boxes and the set of tokens by:
generating, from a subset of the set of hidden states, one or more bounding boxes of the set of bounding boxes; and
generating, from the subset of the set of hidden states, one or more tokens that correspond to the one or more bounding boxes.

11. The system of claim 8, further comprising instructions that, when executed by the at least one processor, cause the system to generate the set of bounding boxes and the set of tokens by:
generating the set of tokens in accordance with a markup language format comprising content tokens indicating text extracted from the image of the document, record tags indicating that one or more content tokens associated with a record tag correspond to a record in the image of the document, and field tags indicating that one or more content tokens associated with a field tag correspond to a field in the image of the document.

12. The system of claim 8, further comprising instructions that, when executed by the at least one processor, cause the system to:
generating a depiction of the bounding box group as a positional rectangle enclosing a portion of the image comprising information associated with a field or record of the image, wherein the subset of tokens of the set of tokens corresponds to the information associated with the field or record of the image.

13. The system of claim 8, further comprising instructions that, when executed by the at least one processor, cause the system to:
generate the set of bounding boxes, the set of tokens, the set of hidden states, or a combination thereof utilizing the record generation model trained by:
generating a set of training tokens and a set of training boxes for a training image;
masking one or more training boxes in the set of training boxes; and
updating one or more parameters of the record generation model based on a loss associated with masking the one or more training boxes.

14. The system of claim 13, wherein the record generation model is further trained by:
generating a prediction of data based on masking the one or more training boxes;
determining the loss associated with masking the one or more training boxes by comparing the prediction of data with training data associated with the training image; and
determining that a masked training box of the one or more training boxes corresponds to a subset of training tokens based on the loss satisfying a threshold loss.

15. A non-transitory computer-readable medium storing instructions that, when executed by at least one processor, cause a computing device to:
generate, utilizing a transformer component and a decoder component of a record generation model, a set of hidden states for an image of a document from a client device;
generate, utilizing a first head component and a second head component of the record generation model, a set of bounding boxes and a set of tokens from the set of hidden states, each bounding box of the set of bounding boxes corresponding to a respective token of the set of tokens;
aggregate, utilizing a matcher component of the record generation model, a plurality of bounding boxes of the set of bounding boxes into a bounding box group that corresponds to a subset of tokens of the set of tokens; and
provide, for display within a graphical user interface of the client device, the image depicting the bounding box group that corresponds to the subset of tokens.

16. The non-transitory computer-readable medium of claim 15, further comprising instructions that, when executed by the at least one processor, cause the computing device to:
pair, utilizing the matcher component, each bounding box of the bounding box group to a respective token of the subset of tokens based on the respective token corresponding to a field tag or a record tag.

17. The non-transitory computer-readable medium of claim 15, further comprising instructions that, when executed by the at least one processor, cause the computing device to:
generate, from a subset of the set of hidden states, one or more bounding boxes of the set of bounding boxes; and
generate, from the subset of the set of hidden states, one or more tokens that correspond to the one or more bounding boxes.

18. The non-transitory computer-readable medium of claim 15, further comprising instructions that, when executed by the at least one processor, cause the computing device to:
generate the set of tokens in accordance with a markup language format comprising content tokens indicating text extracted from the image of the document, record tags indicating that one or more content tokens associated with a record tag correspond to a record in the image of the document, and field tags indicating that one or more content tokens associated with a field tag correspond to a field in the image of the document.

19. The non-transitory computer-readable medium of claim 15, further comprising instructions that, when executed by the at least one processor, cause the computing device to:
generate a depiction of the bounding box group as a positional rectangle enclosing a portion of the image comprising information associated with a field or record of the image, wherein the subset of tokens of the set of tokens corresponds to the information associated with the field or record of the image.

20. The non-transitory computer-readable medium of claim 15, further comprising instructions that, when executed by the at least one processor, cause the computing device to:
generate the set of bounding boxes, the set of tokens, the set of hidden states, or a combination thereof utilizing the record generation model trained by:
generating a set of training tokens and a set of training boxes for a training image;
masking one or more training boxes in the set of training boxes; and
updating one or more parameters of the record generation model based on a loss associated with masking the one or more training boxes.
